(19) United States
(12) Patent Application Publication
(10) Pub. No.: US 2019/0016339 A1
(43) Pub. Date: Jan. 17, 2019

(54) VEHICLE CONTROL DEVICE, VEHICLE CONTROL METHOD, AND VEHICLE CONTROL PROGRAM

(71) Applicant: HONDA MOTOR CO., LTD., Minato-ku, Tokyo (JP)

(72) Inventor: Atsushi Ishioka, Wako-shi (JP)

(21) Appl. No.: 16/067,627

(22) PCT Filed: Feb. 2, 2017
(86) PCT No.: PCT/JP2017/004357

§ 371 Date: Jul. 2, 2018

(30) Foreign Application Priority Data
Feb. 16, 2016 (JP) 2016-027000

(51) Int. Cl. B60W 30/18; B60W 30/095; G08G 1/16; G05D 1/00; G05D 1/02

(52) U.S. Cl. CPC B60W 30/18163; B60W 30/0956; G08G 1/167; G05D 1/0088; G05D 2201/0213; B60W 2550/302; B60W 2550/304; B60W 2550/306; G05D 1/0223

(57) ABSTRACT

This vehicle control device is provided with: a detection unit configured to detect surrounding vehicles traveling in the surroundings of the host vehicle; a first estimation unit configured to estimate the future position in the travelling direction of the aforementioned surrounding vehicles detected by the detection unit; a correction unit configured to correct the distribution of the future position in the travelling direction of the surrounding vehicles estimated by the first estimation unit; said distribution having a spread in the travelling direction with an elapse of time; and a control unit configured to, on the basis of the distribution of the surrounding vehicles corrected by the correction unit, generate a target trajectory of the host vehicle for changing lanes while avoiding the aforementioned surrounding vehicles which are traveling in adjacent lanes adjacent to the host vehicle.

### TECHNICAL FIELD

The present invention relates to a vehicle control device, a vehicle control method, and a vehicle control program.

Priority is claimed on Japanese Patent Application No. 2016-027000, filed Feb. 16, 2016, the content of which is incorporated herein by reference.

### BACKGROUND ART

In recent years, a technology for automatically controlling at least one of the acceleration/deceleration and steering of a host vehicle such that the host vehicle travels along a route to a destination has been studied. With respect to this technology, a driving assistant device is known, which includes an indication means for indicating start of automatic driving of a host vehicle according to an operation of a driver, a setting means for setting a destination of the host vehicle, a determination means for determining an automatic driving mode on the basis of whether the destination has been set when the driver operates the indication means, and a control means for controlling traveling of the vehicle on the basis of the automatic driving mode determined by the determination means, wherein the determination means determines the automatic driving mode as automatic driving or automatic stopping in which the host vehicle travels along a current traveling path when the destination has not been set (for example, refer to Patent Literature 1).

### CITATION LIST

### Patent Literature

### Patent Literature 1

International Publication No. WO2011/158347

### SUMMARY OF INVENTION

### Technical Problem

When a vehicle is automatically controlled, a function of automatically changing lanes may be required.

However, conventional technologies may not be able to generate a target trajectory for lane change of a host vehicle with high accuracy in sufficient consideration of future locations of surrounding vehicles.

Embodiments according to the present invention are devised to solve this problem and an object of the present invention is to provide a vehicle control device, a vehicle control method, and a vehicle control program capable of generating a trajectory for changing lanes with higher accuracy.

### Solution to Problem

(1) A vehicle control device according to one embodiment of the present invention includes: a detection unit configured to detect surrounding vehicles traveling around a host vehicle; a first estimation unit configured to estimate future locations in a travelling direction of the surrounding vehicles detected by the detection unit; a correction unit configured to correct a distribution of the future locations in the travelling direction of the surrounding vehicles estimated by the first estimation unit, the distribution having a spread in the travelling direction with an elapse of time; and a control unit configured to, on the basis of the distribution of the surrounding vehicles corrected by the correction unit, generate a target trajectory of the host vehicle for changing lanes while avoiding the surrounding vehicles traveling on lanes adjacent to a host lane.

(2) In the embodiment of (1), the correction unit may correct the distribution such that an edge of the distribution approaches a side which interferes with a lane change destination of the host vehicle.

(3) In the embodiment of (1) or (2), the first estimation unit may estimate the future locations in the travelling direction of the surrounding vehicles on the assumption that the surrounding vehicles travel while maintaining current speeds or on the assumption that the surrounding vehicles travel while maintaining current accelerations.

(4) In the embodiment of any of (1) to (3), the vehicle control device may further include: a second estimation unit configured to estimate future locations in a lateral direction of the surrounding vehicles detected by the detection unit; and a calculation unit configured to calculate a limit time of lane change of the host vehicle on the basis of the future locations in the lateral direction of the surrounding vehicles estimated by the second estimation unit, wherein the control unit may generate the target trajectory of the host vehicle on the basis of the distribution of the surrounding vehicles corrected by the correction unit and the limit time calculated by the calculation unit.

(5) In the embodiment of (4), the second estimation unit may estimate a distribution of the future locations in the lateral direction of the surrounding vehicles, the distribution having a spread in the lateral direction, and the calculation unit may calculate the limit time on the basis of a time at which integral values of probability density functions corresponding to lane change destinations of the surrounding vehicles change from values less than a threshold value to values equal to or greater than the threshold value in the distribution estimated by the second estimation unit.

(6) In the embodiment of (4) or (5), the second estimation unit may estimate the future locations in the lateral direction of the surrounding vehicles on the basis of road information of roads around the surrounding vehicles.

(7) A vehicle control device according to one embodiment of the present invention includes: a detection unit configured to detect surrounding vehicles traveling around a host vehicle; an estimation unit configured to estimate future locations in the lateral direction of the surrounding vehicles detected by the detection unit; a calculation unit configured to calculate a limit time of lane change of the host vehicle on the basis of the future locations in the lateral direction of the surrounding vehicles estimated by the estimation unit; and a control unit configured to, on the basis of the limit time calculated by the calculation unit, generate a target trajectory of the host vehicle for changing lanes while avoiding the surrounding vehicles traveling on lanes adjacent to a host lane.

(8) According to one embodiment of the present invention, a vehicle control method, performed by a computer, includes: detecting surrounding vehicles traveling around a host vehicle; estimating future locations in a travelling direction of the surrounding vehicles; correcting a distribution of the future locations in the travelling direction of the surrounding vehicles, the distribution having a spread in the travelling direction with the elapse of time; and generating a target trajectory of the host vehicle for changing lanes while avoiding the surrounding vehicles traveling on lanes adjacent to a host lane on the basis of the corrected distribution of the surrounding vehicles.

(9) According to one embodiment of the present invention, a vehicle control program for causing a computer to execute a process includes: detecting surrounding vehicles traveling around a host vehicle; estimating future locations in a travelling direction of the surrounding vehicles; correcting a distribution of the future locations in the travelling direction of the surrounding vehicles, the distribution having a spread in the travelling direction with the elapse of time; and generating a target trajectory of the host vehicle for changing lanes while avoiding the surrounding vehicles traveling on lanes adjacent to a host lane on the basis of the corrected distribution of the surrounding vehicles.

### Advantageous Effects of Invention

According to the above-described embodiments (1) to (3), (8) and (9), the control unit can generate a trajectory for changing lanes with higher accuracy by generating a target trajectory of the host vehicle for changing lanes while avoiding surrounding vehicles traveling on lanes adjacent to a host vehicle on the basis of future locations of the surrounding vehicles which are obtained by correcting future locations in the travelling direction of the surrounding vehicles, which have been estimated by the first estimation unit, on the basis of a distribution having a spread in the travelling direction with the elapse of time.

According to the above-described embodiments of (4) and (5), the control unit can further generate a trajectory for changing lanes also in consideration of an error in the lateral direction of the surrounding vehicles by generating a target trajectory of future locations of the host vehicle for changing lanes while avoiding surrounding vehicles traveling on lanes adjacent to the host vehicle on the basis of future locations in the lateral direction of the surrounding vehicles, which have been corrected by the correction unit, and a limit time calculated by the calculation unit.

According to the above-described embodiment of (6), the second estimation unit can estimate future locations in the lateral direction of the surrounding vehicles with higher accuracy by estimating the future locations in the lateral direction of the surrounding vehicles on the basis of road information of roads around the surrounding vehicles.

According to the above-described embodiment of (7), the control unit can generate a trajectory for changing lanes with higher accuracy by generating a target trajectory of future locations of the host vehicle for changing lanes while avoiding the surrounding vehicles traveling on lanes adjacent to the host lane on the basis of a limit time calculated by the calculation unit.

### BRIEF DESCRIPTION OF DRAWINGS

FIG. 1 is a diagram illustrating components of a vehicle equipped with a vehicle control device according to a first embodiment.

FIG. 2 is a diagram illustrating a functional configuration of a host vehicle focusing on the vehicle control device according to the first embodiment.

FIG. 3 is a diagram illustrating recognition of a relative location of a host vehicle with respect to a travel lane through a host vehicle location recognition unit.

FIG. 4 is a diagram illustrating an example of an action plan generated with respect to a certain section.

FIG. 5A is a diagram illustrating an example of a trajectory generated by a first trajectory generation unit.

FIG. 5B is a diagram illustrating an example of a trajectory generated by the first trajectory generation unit.

FIG. 5C is a diagram illustrating an example of a trajectory generated by the first trajectory generation unit.

FIG. 5D is a diagram illustrating an example of a trajectory generated by the first trajectory generation unit.

FIG. 6 is a diagram illustrating setting of a target location through a target location setting unit in the first embodiment.

FIG. 7 is a flowchart illustrating a process flow executed by a lane change control unit.

FIG. 8 is a diagram illustrating a lane change permissible area based on future locations of surrounding vehicles.

FIG. 9 is a diagram illustrating an example of correction of future displacements of surrounding vehicles.

FIG. 10 is a diagram illustrating generation of a trajectory through a second trajectory generation unit in the first embodiment.

FIG. 11 is a diagram illustrating a functional configuration of a host vehicle focusing on a vehicle control device according to a second embodiment.

FIG. 12 is a flowchart illustrating an example of a process flow through which a second estimation unit derives a probability density distribution of future locations.

FIG. 13 is a diagram schematically illustrating derivation of a probability density distribution.

FIG. 14 is an example of a probability density distribution.

FIG. 15 is an example of a probability density distribution derived in consideration of road information.

FIG. 16 is an example of a probability density distribution derived regardless of road information when a road branches off.

FIG. 17 is an example of a probability density distribution derived in consideration of road information when a road branches off.

FIG. 18 is a diagram for describing derivation of probability density distributions of future locations of surrounding vehicles.

FIG. 19 is a flowchart illustrating a process flow executed by a lane change control unit.

FIG. 20 is a diagram illustrating an example of correction of future displacements of surrounding vehicles of the second embodiment.

FIG. 21 is a diagram illustrating a functional configuration of a host vehicle focusing on a vehicle control device according to a third embodiment.

FIG. 22 is a flowchart illustrating a process flow executed by a lane change control unit.

FIG. 23 is a diagram illustrating an example of correction of future displacements of surrounding vehicles of the third embodiment.

### DESCRIPTION OF EMBODIMENTS

Hereinafter, embodiments of a vehicle control device, a vehicle control method and a vehicle control program of the present invention will be described with reference to the drawings.

### First Embodiment

[Vehicle Configuration]

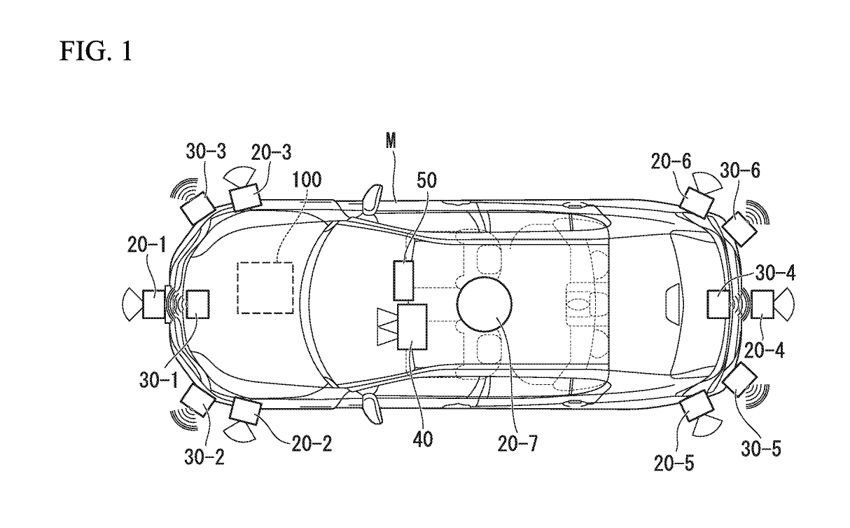

FIG. 1 is a diagram illustrating components of a vehicle (hereinafter referred to as a host vehicle M) equipped with a vehicle control device 100 according to a first embodiment. The vehicle equipped with the vehicle control device 100 is a two-wheeled, three-wheeled or four-wheeled car, for example, and includes a car having an internal combustion engine such as a diesel engine and a gasoline engine as a power source, an electric car having a motor as a power source, a hybrid car including both an internal combustion engine and a motor, etc. In addition, the aforementioned electric car is driven using power discharged from a battery such as a secondary cell, a hydrogen fuel cell, a metallic fuel cell and an alcohol fuel cell, for example.

As shown in FIG. 1, the host vehicle M is equipped with sensors such as finders 20-1 to 20-7, radars 30-1 to 30-6 and a camera 40, a navigation device 50, and the aforementioned vehicle control device 100. For example, the finders 20-1 to 20-7 may use light detection and ranging (LIDAR) (or laser imaging detection and ranging) which measures scattered light with respect to radiated light and measures a distance to a target. For example, the finder 20-1 may be attached to a front grille or the like and the finders 20-2 and 20-3 may be attached to the sides of the car body, door mirrors, inside of headlights, regions near the side indicator lights, and the like. The finder 20-4 may be attached to a trunk lid or the like and the finders 20-5 and 20-6 may be attached to the sides of the car body, inside of taillights or the like. For example, the aforementioned finders 20-1 to 20-6 may have a detection area of about 150 degrees with respect to the horizontal direction. In addition, the finder 20-7 may be attached to a roof or the like. For example, the finder 20-7 may have a detection area of 360 degrees with respect to the horizontal direction.

For example, the aforementioned radars 30-1 and 30-4 may be long-range millimeter-wave radars having a wider detection area in the depth direction than other radars. In addition, the radars 30-2, 30-3, 30-5 and 30-6 are medium-range millimeter-wave radars having a narrower detection area in the depth direction than the radars 30-1 and 30-4. Hereinafter, the finders 20-1 to 20-7 will be simply described as a “finder 20” when they are not particularly distinguished between and the radars 30-1 to 30-6 will be simply described as a “radar 30” when they are not particularly distinguished from. The radar 30 detects an object using a frequency modulated continuous wave (FM-CW) method, for example.

The camera 40 is a digital camera using a solid-state imaging device such as a charge coupled device (CCD) and a complementary metal oxide semiconductor (CMOS), for example. The camera 40 is attached to an upper portion of a front windshield, the rear side of an interior mirror, or the like. For example, the camera 40 periodically repeatedly captures an image in front of the host vehicle M.

Additionally, the configuration shown in FIG. 1 is an example and part of the configuration may be omitted or another configuration may be added.

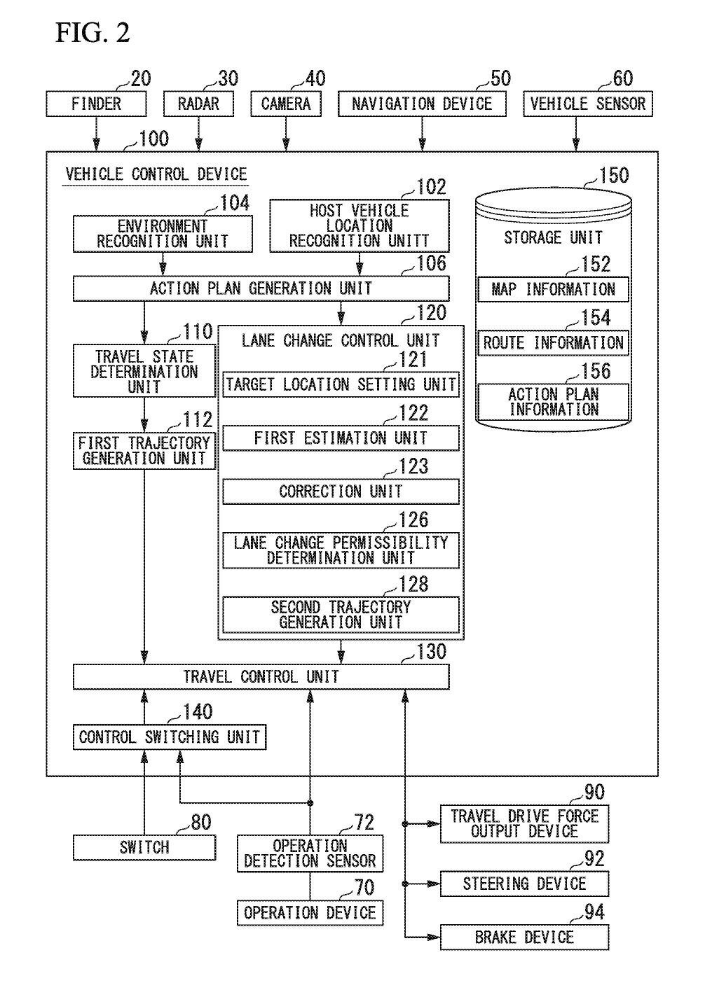

FIG. 2 is a diagram illustrating a functional configuration of the host vehicle M focusing on the vehicle control device 100 according to the first embodiment. The host vehicle M is equipped with a navigation device 50, a vehicle sensor 60, an operation device 70, an operation detection sensor 72, a switch 80, a travel drive force output device 90, a steering device 92, a brake device 94 and a vehicle control device 100 in addition to the finder 20, the radar 30 and the camera 40. These devices and apparatuses are connected through a multi-communication line such as a controller area network (CAN) communication line, a serial communication line, a wireless communication network or the like.

The navigation device 50 may be a global navigation satellite system (GNSS) receiver, map information (navigation maps), a touch panel type display device serving as a user interface, a speaker, a microphone, etc. The navigation device 50 identifies a location of the host vehicle M through the GNSS receiver and derives a route from the location to a destination designated by a user. The route derived by the navigation device 50 is stored in a storage unit 150 as route information 154. The location of the host vehicle M may be identified or complemented by an inertial navigation system (INS) using the output of the vehicle sensor 60. In addition, the navigation device 50 provides guidance for the route to the destination through voice and navigation display when the vehicle control device 100 operates in a manual driving mode. Additionally, a component for identifying the location of the host vehicle M may be installed independently of the navigation device 50. Further, the navigation device 50 may be realized according to a function of a terminal device such as a smartphone or a tablet terminal carried by the user, for example. In this case, transmission and reception of information are performed between the terminal device and the vehicle control device 100 through wireless or wired communication.

The vehicle sensor 60 may be a vehicle speed sensor which detects a vehicle speed, an acceleration sensor which detects acceleration, a yaw rate sensor which detects an angular velocity on the vertical axis, an azimuth sensor which detects a direction of the host vehicle M, etc.

The operation device 70 includes an accelerator pedal, a steering wheel, a brake pedal, a shift lever, etc., for example. An operation detection sensor 72 which detects presence or absence and the quantity of an operation performed by a driver is attached to the operation device 70. For example, the operation detection sensors 72 may include an accelerator opening sensor, a steering torque sensor, a brake sensor, a shift position sensor, etc. The operation detection sensors 72 may output an accelerator opening degree, a steering torque, a brake depression amount, a shift position, etc. to a travel control unit 130 as detection results. Alternatively, detection results of the operation detection sensor 72 may be directly output to the travel drive force output device 90, the steering device 92 or the brake device 94.

The switch 80 is operated by the driver and the like. For example, the switch 80 may be a mechanical switch provided on a steering wheel, a trim (dashboard) or the like or may be a graphical user interface (GUI) switch provided to the touch panel of the navigation device 50. The switch 80 receives an operation of the driver and the like, generates a control mode designation signal for designating a control mode of the travel control unit 130 as any one of an automatic driving mode and a manual driving mode, and outputs the control mode designation signal to a control switching unit 140. The automatic driving mode is a driving mode in which the vehicle travels in a state in which the driver does not operate the vehicle (or an operation amount is small or an operation frequency is low compared to the manual driving mode). More specifically, the automatic driving mode is a driving mode of controlling some or all of the travel drive force output device 90, the steering device 92 and the brake device 94 on the basis of an action plan.

The travel drive force output device 90 includes an engine and an engine electronic control unit (ECU) for controlling the engine when the host vehicle M is a car having an internal combustion engine as a power source, includes a motor for traveling and a motor ECU for controlling the motor for traveling when the host vehicle M is an electric car having a motor as a power source, and includes an engine, an engine ECU, a motor for traveling and a motor ECU when the host vehicle M is a hybrid car, for example. When the travel drive force output device 90 includes only an engine, the engine ECU adjusts a throttle opening, a shift stage, etc. according to information input from the travel control unit 130 which will be described later and outputs a travel drive force (torque) for the vehicle to travel. In addition, when the travel drive force output device 90 includes only a motor for traveling, the motor ECU adjusts a duty ratio of a PWM signal applied to the motor for traveling according to information input from the travel control unit 130 and outputs the aforementioned travel drive force. Further, when the travel drive force output device 90 includes an engine and a motor for traveling, both the engine ECU and the motor ECU control the travel drive force in cooperation with each other according to information input from the travel control unit 130.

The steering device 92 includes an electric motor, a steering torque sensor, a steering angle sensor and the like, for example. For example, the electric motor applies a force with respect to a rack and pinion function and the like to change the direction of the steering wheel. The steering torque sensor detects torsion of a torsion bar when the steering wheel is operated as a steering torque (steering force), for example. The steering angle sensor detects a steering angle (or an actual steering angle), for example. The steering device 92 drives the electric motor according to information input from the travel control unit 130 to change the direction of the steering wheel.

The brake device 94 is an electric servo brake device including a brake caliper, a cylinder which delivers oil pressure to the brake caliper, an electric motor which causes the cylinder to generate oil pressure, and a brake control unit, for example. The brake control unit of the electric servo brake device controls the electric motor according to information input from the travel control unit 130 and outputs a brake torque in response to a brake operation to each wheel. The electric servo brake device may include a mechanism for delivering oil pressure generated by operating a brake pedal to the cylinder through a master cylinder as backup. Further, the brake device 94 is not limited to the above-described electric servo brake device and may be an electronically controlled hydraulic brake device. The electronically controlled hydraulic brake device controls an actuator according to information input from the travel control unit 130 to deliver oil pressure of the master cylinder to the cylinder. In addition, the brake device 94 may include a regenerative brake according to the motor for traveling described with reference to the travel drive force output device 90.

[Vehicle Control Device]

Hereinafter, the vehicle control device 100 will be described. The vehicle control device 100 includes, for example, a host vehicle location recognition unit 102, an environment recognition unit 104, an action plan generation unit 106, a travel state determination unit 110, a first trajectory generation unit 112, a lane change control unit 120, the travel control unit 130, a control switching unit 140, and the storage unit 150. Some or all of the host vehicle location recognition unit 102, the environment recognition unit 104, the action plan generation unit 106, the travel state determination unit 110, the first trajectory generation unit 112, the lane change control unit 120, the travel control unit 130 and a control switching unit 140 are software functional units which function according to the execution of programs by a processor such as a central processing unit (CPU). Further, some or all of these components may be hardware functional units such as a large scale integration (LSI) or an application specific integrated circuits (ASICs). In addition, the storage unit 150 may be realized by a read only memory (ROM), a random access memory (RAM), a hard disk drive (HDD), a flash memory or the like. The programs executed by the processor may be stored in the storage unit 150 in advance or downloaded from an external device through Internet equipment mounted on the vehicle. Further, the programs may be installed in the storage unit 150 by mounting a portable storage medium in which the programs are stored in a drive device that is not shown.

The host vehicle location recognition unit 102 recognizes a lane (travel lane) on which the host vehicle M is traveling and a relative location of the host vehicle M with respect to the travel lane on the basis of map information 152 stored in the storage unit 150 and information input from the finder 20, the radar 30, the camera 40, the navigation device 50 or the vehicle sensor 60. For example, the map information 152 may be map information which is more accurate than the navigation maps included in the navigation device 50 and includes information on centers of lanes or information on boundaries of lanes. More specifically, the map information 152 includes road information, traffic regulations information, address information (addresses and zip codes), facility information, telephone number information, etc. The road information includes information indicating road types such as an expressway, a toll road, a national highway and a prefectural road, and information such as the number of lanes of a road, the width of each lane, gradients of roads, locations of roads (three-dimensional coordinates including latitudes, longitudes and heights), curvatures of curves of roads, locations of merging and branching points of lanes and signs installed on roads. The traffic regulations information includes information about roadwork, traffic accidents, and blocking of lanes due to traffic jams and the like.

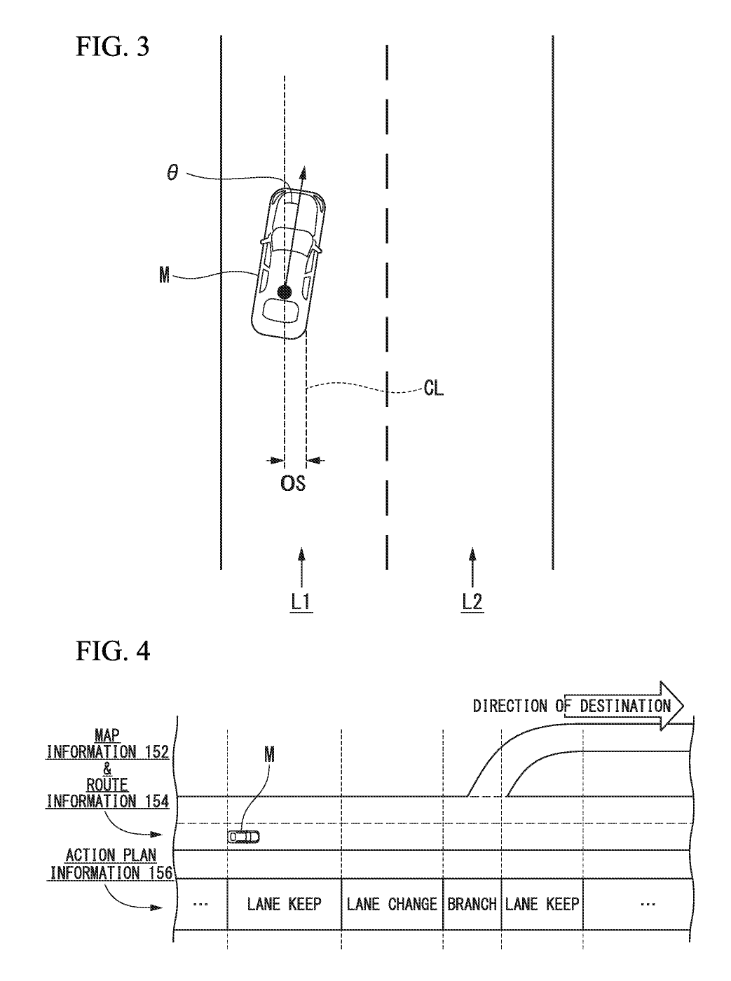

FIG. 3 is a diagram illustrating recognition of a relative location of the host vehicle M with respect to a travel lane L1 through the host vehicle location recognition unit 102. For example, the host vehicle location recognition unit 102 recognizes a gap OS between a reference point (e.g., the center) of the host vehicle M and a travel lane center CL, and an angle θ of the travelling direction of the host vehicle M to a line connecting the travel lane center CL as a relative location of the host vehicle M with respect to the travel lane L1. Alternatively, the host vehicle location recognition unit 102 may recognize the location of the reference point of the host vehicle M with respect to any one of side edges of the travel lane L1, or the like as a relative location of the host vehicle M with respect to the travel lane.

The environment recognition unit 104 recognizes states such as locations, speeds and accelerations of surrounding vehicles on the basis of information input from the finder 20, the radar 30, the camera 40 and the like. A surrounding vehicle in the present embodiment is a vehicle traveling around the host vehicle M in the same direction as the direction in which the host vehicle M is traveling. A location of a surrounding vehicle may be indicated by a representative point such as the center or a corner of the surrounding vehicle or a region represented as an outline of the surrounding vehicle. A “state” of a surrounding vehicle may include whether the acceleration of the surrounding vehicle or the lane thereof is being changed (or whether lane change is intended) on the basis of information on the above-described various devices. In addition, the environment recognition unit 104 may recognize locations of guardrails, telegraph poles, parked vehicles, pedestrians and other objects in addition to surrounding vehicles.

The action plan generation unit 106 generates an action plan in a predetermined section. For example, the predetermined section is a section in which the vehicle passes through a toll road such as an expressway among routes derived by the navigation device 50. The present invention is not limited thereto and the action plan generation unit 106 may generate an action plan with respect to any section.

An action plan is composed of a plurality of sequentially executed events, for example. For example, events include a deceleration event of reducing the speed of the host vehicle M, an acceleration event of increasing the speed of the host vehicle M, a lane keep event of causing the host vehicle M to travel without leaving a travel lane, a lane change event of changing travel lanes, a passing event of causing the host vehicle M to pass a preceding vehicle, a branching event of changing lanes to a desired lane at a branching point or causing the host vehicle M to travel without leaving the current travel lane, a merging event of increasing or decreasing the speed of the host vehicle M on a lane to merge into a main line and changing travel lanes, and the like. For example, when there is a junction (intersection) on a toll road (e.g., an expressway and the like), the vehicle control device 100 needs to change or maintain lanes such that the host vehicle M travels in the direction of a destination in the automatic driving mode. Accordingly, when it is confirmed that a junction exists on a road with reference to the map information 152, the action plan generation unit 106 sets a lane change event for changing to a desired lane through which the host vehicle M can travel in the direction of the destination between the current location (coordinates) of the host vehicle M and the location (coordinates) of the junction. Additionally, information indicating an action plan generated by the action plan generation unit 106 is stored in the storage unit 150 as action plan information 156.

FIG. 4 is a diagram illustrating an example of an action plan generated with respect to a certain section. As shown in FIG. 4, the action plan generation unit 106 classifies situations occurring when the host vehicle M travels along a route to a destination and generates an action plan such that an event suitable for each situation is executed. Additionally, the action plan generation unit 106 may dynamically change an action plan in response to change in the situation of the host vehicle M.

For example, the action plan generation unit 106 may change (update) a generated action plan on the basis of an environment state recognized by the environment recognition unit 104. In general, environment states constantly change while a vehicle is traveling. Particularly, when the host vehicle M travels on a road including a plurality of lanes, distances from surrounding vehicles relatively change. For example, when a preceding vehicle is abruptly braked to reduce the speed or a vehicle traveling on an adjacent lane cuts in front of the host vehicle M, the host vehicle M needs to travel while appropriately changing the speed and lanes according to the behavior of the preceding vehicle and the behavior of the vehicle on the adjacent lane. Accordingly, the action plan generation unit 106 may change an event set for each control section in response to variation in environment states as described above.

Specifically, when the speed of a surrounding vehicle recognized by the environment recognition unit 104 exceeds a threshold value during vehicle is traveling or a surrounding vehicle traveling on a lane adjacent to the corresponding lane moves in the direction of the corresponding lane, the action plan generation unit 106 changes an event set for a driving section in which the host vehicle M will travel. For example, in a case in which events are set such that a lane change event is executed after a lane keep event, when it is confirmed that the vehicle has progressed at a speed equal to or greater than a threshold value after a lane change destination during the lane keep event according to a recognition result of the environment recognition unit 104, the action plan generation unit 106 changes the event following the lane keep event from lane change to a deceleration event, a lane keep event or the like. As a result, the vehicle control device 100 can cause the host vehicle M to automatically travel safely even when an environment state changes.

[Lane Keep Event]

The travel state determination unit 110 determines any travel state of constant-speed travel, following travel, deceleration travel, curve travel, obstacle avoiding travel and the like when a lane keep event included in an action plan is performed by the travel control unit 130. For example, the travel state determination unit 110 determines a travel state as constant-speed travel when there are no surrounding vehicles in front of the host vehicle M. In addition, the travel state determination unit 110 determines a travel state as following travel when following travel is intended with respect to a preceding vehicle. Further, the travel state determination unit 110 determines a travel state as deceleration travel when the environment recognition unit 104 recognizes deceleration of a preceding vehicle or an event such as vehicle stopping, vehicle parking or the like is performed. Further, the travel state determination unit 110 determines a travel state as curve travel when the environment recognition unit 104 recognizes that the host vehicle M comes close to a curved road. In addition, the travel state determination unit 110 determines a travel state as obstacle avoiding travel when the environment recognition unit 104 recognizes an obstacle in front of the host vehicle M.

The first trajectory generation unit 112 generates a trajectory on the basis of a travel state determined by the travel state determination unit 110. A trajectory is a set of points obtained by sampling future target locations, which are assumed will be reached when the host vehicle M travels on the basis of the travel state determined by the travel state determination unit 110, at predetermined time intervals. The first trajectory generation unit 112 calculates a target speed of the host vehicle M on the basis of at least a speed of an object OB existing in front of the host vehicle M, recognized by the host vehicle location recognition unit 102 or the environment recognition unit 104, and a distance between the host vehicle M and the object OB. The first trajectory generation unit 112 generates a trajectory on the basis of the calculated target speed. The object OB includes a preceding vehicle, points such as a merging point, a branching point and a target point, objects such as an obstacle, and the like.

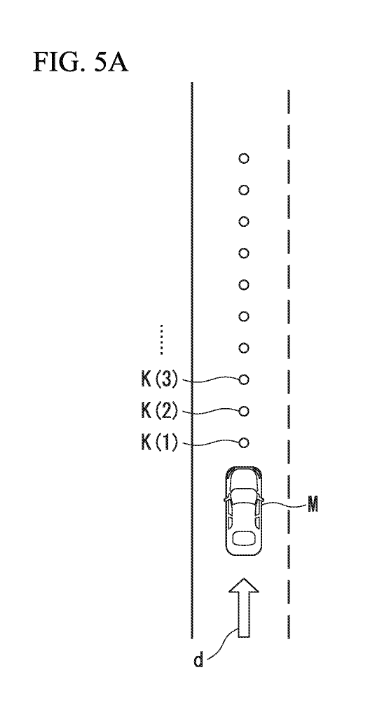

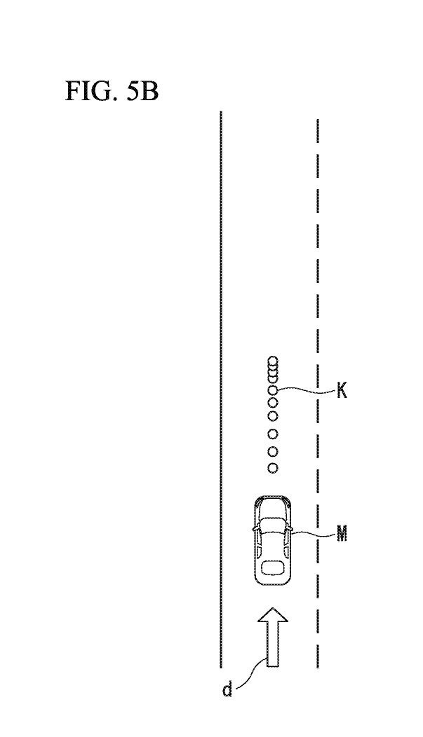

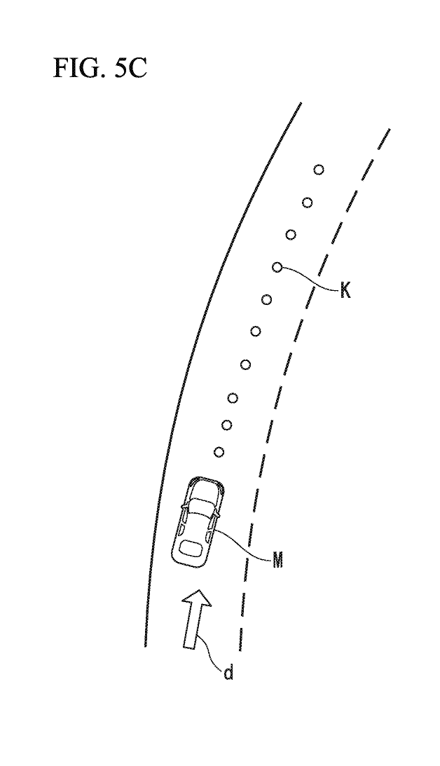

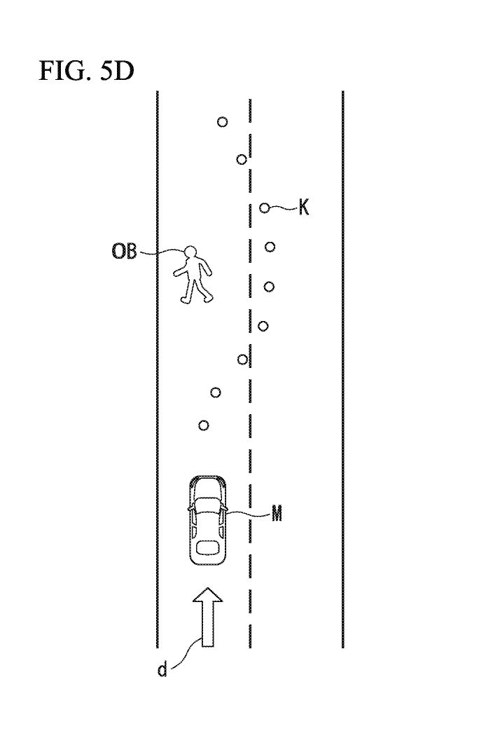

Hereinafter, generation of a trajectory in both a case in which existence of the object OB is not particularly considered and a case in which existence of the object OB is considered will be described. FIGS. 5A to 5D are diagrams illustrating examples of a trajectory generated by the first trajectory generation unit 112. As shown in FIG. 5A, for example, the first trajectory generation unit 112 sets future target locations K(1), K(2), K(3), . . . as a trajectory of the host vehicle M whenever a predetermined time Δt elapses from the current time on the basis of the current location of the host vehicle M. Hereinafter, these target locations will be simply represented as “target location K” when they are not distinguished from. For example, the number of target locations K is determined depending on a target time T_{K}. For example, when the target time T_{K} is set to 5 seconds, the first trajectory generation unit 112 sets target locations K on the central line of a travel lane at intervals of a predetermined time Δt (e.g., 0.1 seconds) in 5 seconds and determines a spacing of the plurality of target locations K on the basis of a travel state. For example, the first trajectory generation unit 112 may derive the central line of the travel lane from information such as the width of the lane included in the map information 152 or may acquire the central line of the travel lane from the map information 152 when it is included in the map information 152 in advance.

For example, when a travel state is determined as constant-speed travel by the aforementioned travel state determination unit 110, the first trajectory generation unit 112 sets a plurality of target locations K at equal intervals to generate a trajectory, as shown in FIG. 5A.

In addition, in a case in which a travel state is determined as deceleration travel (also including a case in which a preceding vehicle reduces the speed in following travel) by the travel state determination unit 110, the first trajectory generation unit 112 generates a trajectory by widening the spacing of target locations K at which the host vehicle M will arrive earlier and narrowing the spacing of target locations K at which the host vehicle M will arrive later, as shown in FIG. 5B. In this case, a preceding vehicle may be set as the object OB or a point such as a merging point, a branching point or a target point, an obstacle or the like other than the preceding vehicle may be set as the object OB. Accordingly, a target point K at which the host vehicle M will arrive later comes closer to the current location of the host vehicle M, and thus the travel control unit 130 which will be described later reduces the speed of the host vehicle M.

In addition, when a road is a curved road as shown in FIG. 5C, the travel state determination unit 110 determines a travel state as curve travel. In this case, the first trajectory generation unit 112 generates a trajectory by arranging a plurality of target locations K while changing lateral locations (which are locations in the direction of the width of a lane which is almost orthogonal to the travelling direction) for the travelling direction of the host vehicle M in response to the curvature of the road, for example. In addition, when there is an obstacle OB such as a person or a stopped vehicle on the road in front of the host vehicle M, as shown in FIG. 5D, the travel state determination unit 110 determines a travel state as obstacle avoiding travel. In this case, the first trajectory generation unit 112 generates a trajectory by arranging a plurality of target locations K such that the host vehicle M travels while avoiding the obstacle OB.

### [Lane Change Event]

The lane change control unit 120 performs control when a lane change event included in an action plan is executed by the travel control unit 130. As shown in FIG. 2, the lane change control unit 120 includes a target location setting unit 121, a first estimation unit 122, a correction unit 123, a lane change permissibility determination unit 126, and a second trajectory generation unit 128, for example. Further, the lane change control unit 120 may perform a process which will be described later when a branching event or a merging event is executed by the travel control unit 130.

The target location setting unit 121 identifies a vehicle which travels on a lane adjacent to a lane (host lane) on which the host vehicle M travels in front of the host vehicle M and a vehicle which travels on the adjacent lane behind the host vehicle M and sets a target location TA between these vehicles. In the following description, a vehicle which travels on an adjacent lane in front of the host vehicle M is referred to as a front reference vehicle and a vehicle which travels on an adjacent lane behind the host vehicle M is referred to as a rear reference vehicle. The target location TA is a relative region based on a relationship of location between the host vehicle M and the front reference vehicle and the rear reference vehicle.

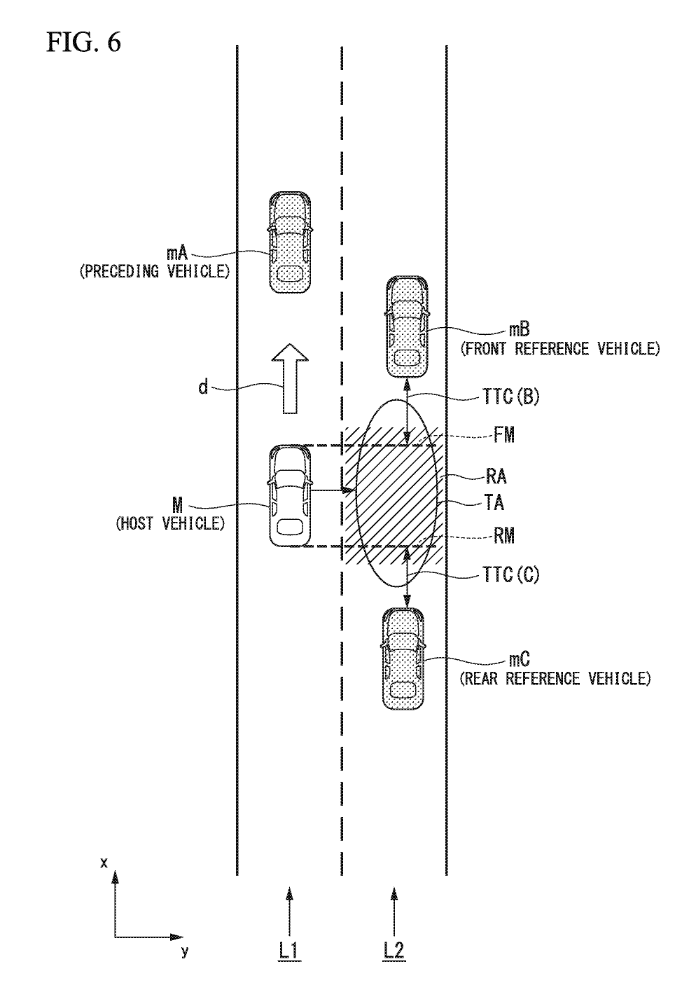

FIG. 6 is a diagram illustrating setting of the target location TA through the target location setting unit 121 in the first embodiment. In FIG. 6, mA indicates a vehicle (preceding vehicle) which travels on a lane on which the host vehicle M is traveling in front of the host vehicle M, mB indicates the front reference vehicle, and mC indicates the rear reference vehicle. In addition, an arrow d indicates a travelling direction of the host vehicle M, L1 indicates the lane on which the host vehicle M is traveling, and L2 indicates an adjacent lane. In the case of the example of FIG. 6, the target location setting unit 121 sets the target location TA between the front reference vehicle mB and the rear reference vehicle mC on the adjacent lane L2.

The first estimation unit 122 estimates future locations in the travelling direction of the surrounding vehicles (e.g., the preceding vehicle, the front reference vehicle and the rear reference vehicle) of the host vehicle M. The correction unit 123 corrects the future locations of the surrounding vehicles, estimated by the first estimation unit 122, on the basis of distributions having a spread in the travelling direction with the elapse of time. Processes of the first estimation unit 122 and the correction unit 123 will be described in detail later.

The lane change permissibility determination unit 126 determines whether lane change to the target location TA (i.e., between the front reference vehicle mB and the rear reference vehicle mC) set by the target location setting unit 121 is permissible. Hereinafter, this will be described with reference to FIG. 6.

First, the lane change permissibility determination unit 126 projects the host vehicle M to the lane L2 corresponding to a lane change destination and sets an inhibition area RA having some allowance distances behind and in front. The inhibition area RA is set as an area extending from one edge of the lane L2 to the other edge in the lateral direction. When there is any portion of a surrounding vehicle in the inhibition area RA, the lane change permissibility determination unit 126 determines that lane change to the target location TA is not permissible.

When there are no surrounding vehicles within the inhibition area RA, the lane change permissibility determination unit 126 further determines whether lane change is permissible on the basis of a time-to collision (TTC) between the host vehicle M and the surrounding vehicles. For example, the lane change permissibility determination unit 126 supposes an extended line FM and an extended line RM obtained by virtually extending the front end and the rear end of the host vehicle M to the lane L2 corresponding to a lane change destination. The extended line FM is a line obtained by virtually extending the front end of the host vehicle M and the extended line RM is a line obtained by virtually extending the rear end of the host vehicle M. The lane change permissibility determination unit 126 calculates a time-to collision TTC(B) of the extended line TM and the front reference vehicle mB and a time-to collision TTC(C) of the extended line RM and the rear reference vehicle mC. The time-to collision TTC(B) is a time derived by dividing the distance between the extended line FM and the front reference vehicle mB by a relative speed between the host vehicle M and the front reference vehicle mB. The time-to collision TTC(C) is a time derived by dividing the distance between the extended line RM and the rear reference vehicle mC by a relative speed between the host vehicle M and the rear reference vehicle mC. The lane change permissibility determination unit 126 determines that the host vehicle M can change lanes to the target location TA when the time-to collision TTC(B) is greater than a threshold value Th(B) and the time-to collision TTC(C) is greater than a threshold value Th(C).

Additionally, the target location setting unit 121 may set the target location TA to the rear reference vehicle mC (between the rear reference vehicle mC and a vehicle behind the rear reference vehicle mC) on the adjacent lane.

In addition, the lane change permissibility determination unit 126 may determine whether the host vehicle M can change lanes within the target location TA by considering the speeds, accelerations, jerks or the like of the preceding vehicle mA, the front reference vehicle mB and the rear reference vehicle mC. For example, when the speeds of the front reference vehicle mB and the rear reference vehicle mC are higher than the speed of the preceding vehicle mA and the front reference vehicle mB and the rear reference vehicle mC are expected to pass the preceding vehicle mA within a period of time necessary for the host vehicle M to change lanes, the lane change permissibility determination unit 126 determines that the host vehicle M cannot change lanes to the target location TA set between the front reference vehicle mB and the rear reference vehicle mC.

The second trajectory generation unit 128 generates a trajectory of future locations of the host vehicle for changing lanes to the target location TA on the basis of a plan for changing lanes, derived by the lane change permissibility determination unit 126. The lane change permissibility determination unit 126 and the second trajectory generation unit 128 are an example of a “control unit.”

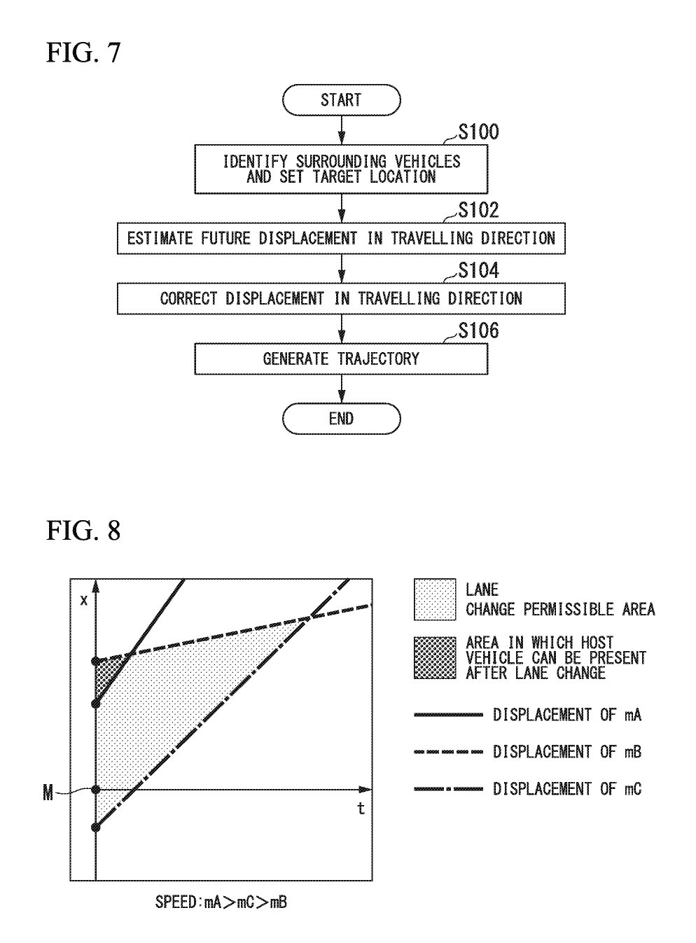

FIG. 7 is a flowchart illustrating a process flow executed by the lane change control unit 120. First, the target location setting unit 121 identifies surrounding vehicles and sets a target location TA between the identified surrounding vehicles (step S100).

Next, the first estimation unit 122 estimates future displacements (future locations) in the travelling direction of the identified surrounding vehicles (e.g., the preceding vehicle mA, the front reference vehicle mB and the rear reference vehicle mC) (step S102). For example, the future displacements estimated in step S102 are predicted on the basis of a constant-speed model based on the assumption that the vehicles will travel while maintaining the current speeds, a constant-acceleration model based on the assumption that the vehicles travel while maintaining current accelerations, a following travel model based on the assumption that a following vehicle travels following a preceding vehicle while maintaining a constant distance from the preceding vehicle, and various other models. In the following description, the future displacements are estimated using the constant-speed model.

FIG. 8 is a diagram illustrating a lane change permissible area based on the future locations of the surrounding vehicles. FIG. 8 illustrates estimated variation in time of the future locations in the travelling direction of the surrounding vehicles. FIG. 8 illustrates a distribution of the future locations in the travelling direction of the surrounding vehicles, which has a spread in the travelling direction with the elapse of time. In FIG. 8, the surrounding vehicles have a relationship of location in which the front reference vehicle mB travels ahead, the preceding vehicle mA follows the front reference vehicle mB, the host vehicle M follows the preceding vehicle mA and the rear reference vehicle mC travels at the end. In FIG. 8, the vertical axis represents a displacement x in the travelling direction having the current location of the host vehicle M as the origin and the horizontal axis represents elapsed time t. In FIG. 8, an area in which the host vehicle M can be present after lane change represents an area of displacement in a travelling direction in which the host vehicle M can be present when the surrounding vehicles continuously travel with the same trend after lane change. For example, the figure shows that the area in which the host vehicle M can be present after lane change is located under the displacement of the preceding vehicle mA, that is, the host vehicle M is restricted from traveling ahead of the preceding vehicle mA before lane change but may travel ahead of the preceding vehicle mA after lane change, when “speed: mA>mC>mB.” The second trajectory generation unit 128 generates a trajectory on the basis of the location relationship illustrated in FIG. 8.

However, since the estimation process of the first estimation unit 122 is performed on the basis of a model such as the constant-speed model, as described above, reliability deteriorates with increasing time into the future. Accordingly, the correction unit 123 corrects the future displacements of the surrounding vehicles, estimated by the first estimation unit 122, on the basis of a distribution having a spread in the travelling direction with the elapse of time (step S104).

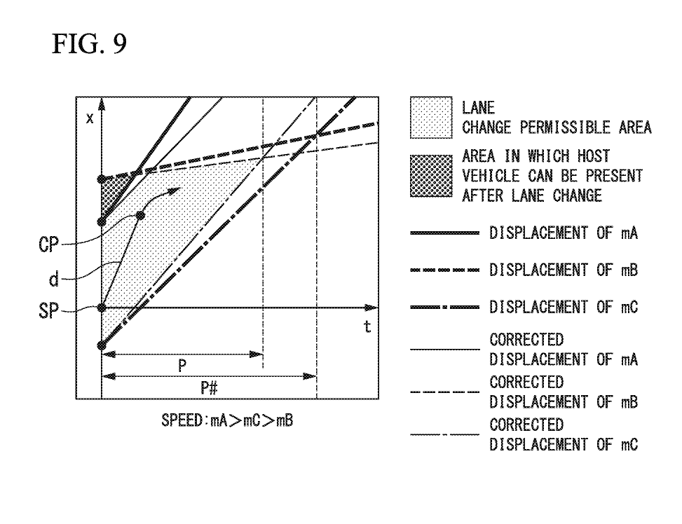

FIG. 9 is a diagram illustrating an example of correction of the future displacements of the surrounding vehicles. The future displacements of the surrounding vehicles, estimated by the first estimation unit 122, tend to have errors increasing with the elapse of time with respect to actual future displacements of the surrounding vehicles. Accordingly, the correction unit 123 corrects future displacements of a surrounding vehicle, estimated by the first estimation unit 122, on the basis of a distribution having a spread in the travelling direction with the elapse of time, for example. The correction unit 123 corrects the future locations of the surrounding vehicles, estimated by the first estimation unit 122, to an edge of the distribution of the surrounding vehicles, which interferes with a lane change destination of the host vehicle M, among the edges of the distribution of the surrounding vehicles, for example. The correction unit 123 corrects the distribution having a spread in the travelling direction with the elapse of time such that the edge of the distribution approaches a side interfering in the lane change destination of the host vehicle. The correction unit 123 corrects the distribution having a spread in the travelling direction with the elapse of time such that the surrounding vehicles become closer to the lane change destination of the host vehicle M with the elapse of time. Specifically, the correction unit 123 corrects the future locations of the surrounding vehicles to the lane change permissible area.

Next, the second trajectory generation unit 128 generates a trajectory for the host vehicle M to change lanes to the target location TA (step S106). The second trajectory generation unit 128 determines a start point SP and an end point CP of lane change on the basis of the future displacements of the surrounding vehicles, corrected in step S104. To determine the lane change start point SP, there are factors called “points at which the surrounding vehicles are located behind the host vehicle M” and “points at which the surrounding vehicles are located in front of the host vehicle M.” To achieve this, assumption with respect to acceleration/deceleration of the host vehicle M may be needed. In regard to this, the second trajectory generation unit 128 derives a speed variation curve using a legal speed limit as an upper limit within a range in which rapid acceleration from the current speed of the host vehicle M does not occur and determines “points in time at which the host vehicle M passes the surrounding vehicles” in accordance with variations in location of the surrounding vehicles in the case of acceleration, for example. In addition, the second trajectory generation unit 128 determines the lane change end point CP at which lane change can be completed avoiding the surrounding vehicles within a lane change permissible period P.

As shown in FIG. 9, a period in which lane change is permissible (lane change permissible period) is changed from “P#” to “P.” The second trajectory generation unit 128 determines the lane change end point CP such that the lane change end point CP precedes the lane change permissible period P. In addition, the second trajectory generation unit 128 generates a trajectory d for changing lanes on the basis of the determined lane change start point SP and end point CP. The second trajectory generation unit 128 determines that the trajectory is realizable when a vehicle behavior for realizing the generated trajectory d meets conditions (instantaneous acceleration/deceleration and yaw rate are within allowable ranges). When the vehicle behavior for realizing the generated trajectory d does not meet the conditions, the second trajectory generation unit 128 determines that lane change is not permissible irrespective of the determination result of the lane change permissibility determination unit 126. When the second trajectory generation unit 128 can generate a plurality of trajectories for changing lanes, the second trajectory generation unit 128 selects one trajectory in view of stability and smoothness. In this manner, the process of the present flowchart is ended.

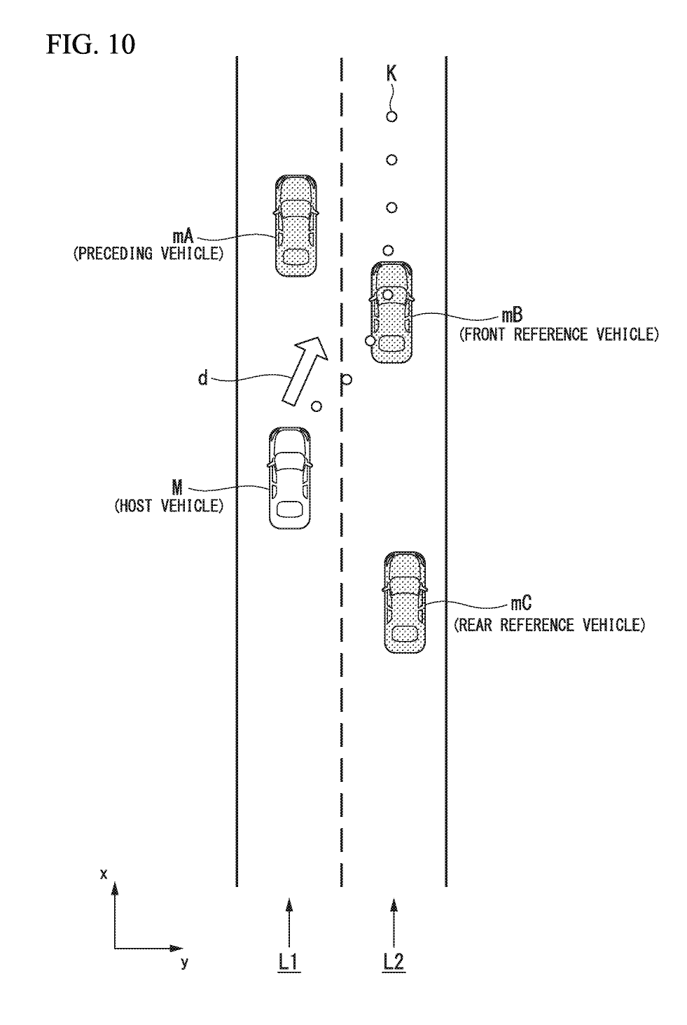

FIG. 10 is a diagram illustrating generation of a trajectory through the second trajectory generation unit 128 in the first embodiment. For example, the second trajectory generation unit 128 smoothly connects the current location of the host vehicle M, the center of a lane change destination, and a location corresponding to the aforementioned lane change end point CP using a polynomial curve such as a spline curve and arranges a predetermined number of target locations K on the curve at equal intervals or unequal intervals. Here, the second trajectory generation unit 128 generates a trajectory such that at least one of the target locations K is within the target location TA.

As described above, the lane change control unit 120 can more accurately generate a trajectory (a target trajectory of future locations) for the host vehicle M to change lanes to an adjacent lane while avoiding surrounding vehicles traveling on the adjacent lane by using a distribution having a spread in the travelling direction with the elapse of time for future locations of the surrounding vehicles.

[Travel Control]

The travel control unit 130 sets a control mode to the automatic driving mode or the manual driving mode according to control of the control switching unit 140 and controls control targets including some or all of the travel drive force output device 90, the steering device 92 and the brake device 94 according to the set control mode. The travel control unit 130 reads the action plan information 156 generated by the action plan generation unit 106 and controls the control targets on the basis of an event included in the read action plan information 156 in the automatic driving mode.

For example, when the event is a lane keep event, the travel control unit 130 determines a control quantity (e.g., the rotational speed) of an electric motor in the steering device 92 and a control quantity (e.g., a throttle opening and shift stage of an engine, and the like) of an ECU in the travel drive force output device 90 according to the trajectory generated by the first trajectory generation unit 112. Specifically, the travel control unit 130 derives the speed of the host vehicle M per predetermined time At on the basis of a distance between target locations K on the trajectory and the predetermined time At when the target locations K are arranged and determines the control quantity of the ECU in the travel drive force output device 90 depending on the speed per predetermined time At. In addition, the travel control unit 130 determines the control quantity of the electric motor in the steering device 92 depending on an angle formed by the travelling direction of the host vehicle M for each target location K and the direction of the next target location based on this target location.

In addition, when the aforementioned event is a lane change event, the travel control unit 130 determines the control quantity of the electric motor in the steering device 92 and the control quantity of the ECU in the travel drive force output device 90 according to the trajectory generated by the second trajectory generation unit 128.

The travel control unit 130 outputs information indicating control quantities determined for each event to a corresponding control target. Accordingly, the devices 90, 92 and 94 of the control targets can be controlled according to the information indicating the control quantities input from the travel control unit 130. Further, the travel control unit 130 appropriately adjusts the determined control quantities on the basis of a detection result of the vehicle sensor 60.

In addition, the travel control unit 130 controls the control targets on the basis of an operation detection signal output from the operation detection sensor 72 in the manual driving mode. For example, the travel control unit 130 outputs the operation detection signal output from the operation detection sensor 72 to each device of the control targets as it is.

The control switching unit 140 switches the control mode of the host vehicle M set by the travel control unit 130 from the automatic driving mode to the manual driving mode or from the manual driving mode to the automatic driving mode on the basis of the action plan information 156 generated by the action plan generation unit 106 and stored in the storage unit 150. Further, the control switching unit 140 switches the control mode of the host vehicle M set by the travel control unit 130 from the automatic driving mode to the manual driving mode or from the manual driving mode to the automatic driving mode on the basis of a control mode designation signal input from the switch 80. That is, the control mode of the travel control unit 130 can be arbitrarily changed during vehicle traveling or stopping according to operation of the driver and the like.

In addition, the control switching unit 140 switches the control mode of the host vehicle M set by the travel control unit 130 from the automatic driving mode to the manual driving mode on the basis of an operation detection signal input from the operation detection sensor 72. For example, when an operation quantity included in the operation detection signal exceeds a threshold value, that is, the operation device 70 is operated with an operation quantity exceeding the threshold value, the control switching unit 140 switches the control mode of the travel control unit 130 from the automatic driving mode to the manual driving mode. For example, when the driver operates the steering wheel, the accelerator pedal or the brake pedal with an operation quantity exceeding a threshold value in a case in which the host vehicle M automatically travels according to the travel control unit 130 set in the automatic driving mode, the control switching unit 140 switches the control mode of the travel control unit 130 from the automatic driving mode to the manual driving mode. Accordingly, the vehicle control device 100 can immediately switch the control mode to the manual driving mode without using the operation of the switch 80 according to instantaneous operation of the driver when an object such as a person dashes into the road or the preceding vehicle mA suddenly stops. As a result, the vehicle control device 100 can cope with operation of the driver in case of emergency to improve stability during traveling.

The vehicle control device 100 according to the first embodiment described above corrects future locations of surrounding vehicles through a distribution having a spread in the travelling direction with the elapse of time and generates a target trajectory of future locations of the host vehicle for changing lanes while avoiding the surrounding vehicles traveling on a lane adjacent to the host vehicle on the basis of the corrected distribution. Consequently, the vehicle control device 100 can generate a trajectory for changing lanes more accurately.

### Second Embodiment

Hereinafter, a second embodiment will be described. In the first embodiment, the vehicle control device 100 generates a future trajectory of the host vehicle M on the basis of corrected future displacements in the travelling direction of the surrounding vehicles of the host vehicle M. On the other hand, a vehicle control device 100A in the second embodiment calculates a lane change limit time from future locations in a direction (lateral direction) orthogonal to the travelling direction of the surrounding vehicles of the host vehicle M. The second embodiment differs from the first embodiment in that the vehicle control device 100A generates the future trajectory of the host vehicle M for changing lanes on the basis of the corrected future displacements in the travelling direction of the surrounding vehicles and the calculated limit time. Hereinafter, such a difference will be mainly described.

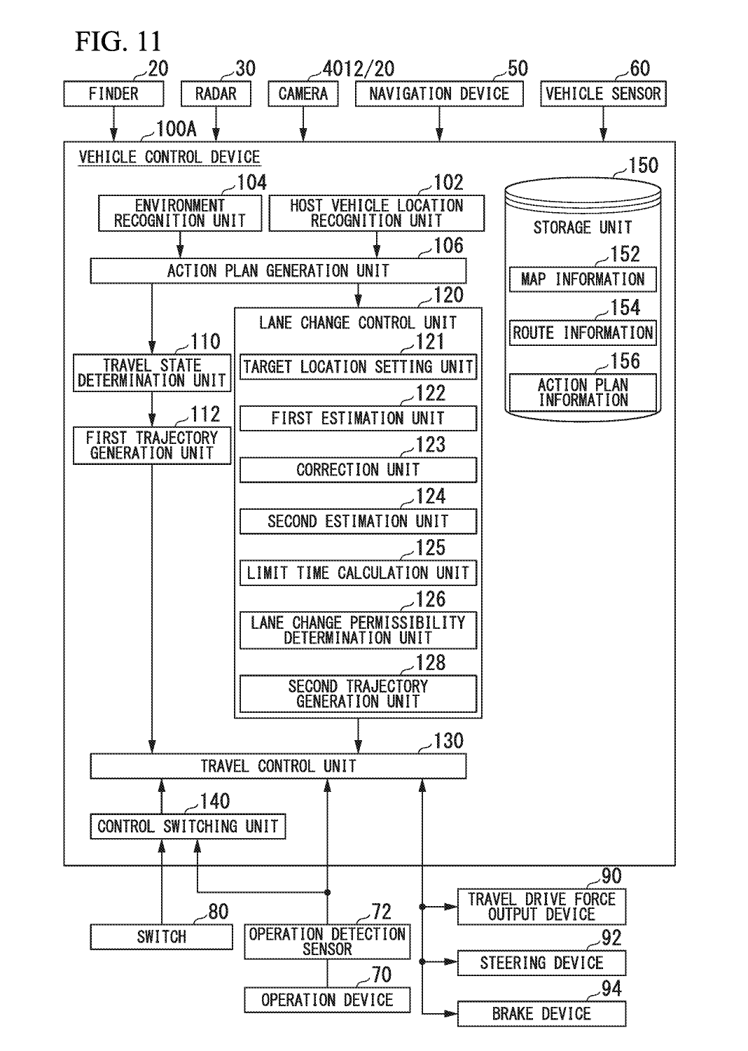

FIG. 11 is a diagram illustrating a functional configuration of the host vehicle M focusing on the vehicle control device 100A according to the second embodiment. The lane change control unit 120 of the vehicle control device 100A further includes a second estimation unit 124 and a limit time calculation unit 125 in addition to the function of the lane change control unit 120 of the first embodiment.

The second estimation unit 124 estimates future locations in the lateral direction of surrounding vehicles. The limit time calculation unit 125 derives a probability density distribution in the lateral direction of the surrounding vehicles on the basis of future locations in the lateral direction of the surrounding vehicles, estimated by the second estimation unit 124. The limit time calculation unit 125 calculates a limit time on the basis of the derived probability density distribution. The limit time is (1) a time at which a surrounding vehicle is expected to change lanes to the target location TA of the host vehicle M or (2) a time at which a surrounding vehicle is expected to change lanes immediately before the host vehicle M prior to completion of lane change of the host vehicle M. When this occurs, a precondition for generation of a trajectory changes and thus the vehicle control device 100 performs control such that lane change is completed before the limit time.

[Method of Deriving Probability Density Distribution]

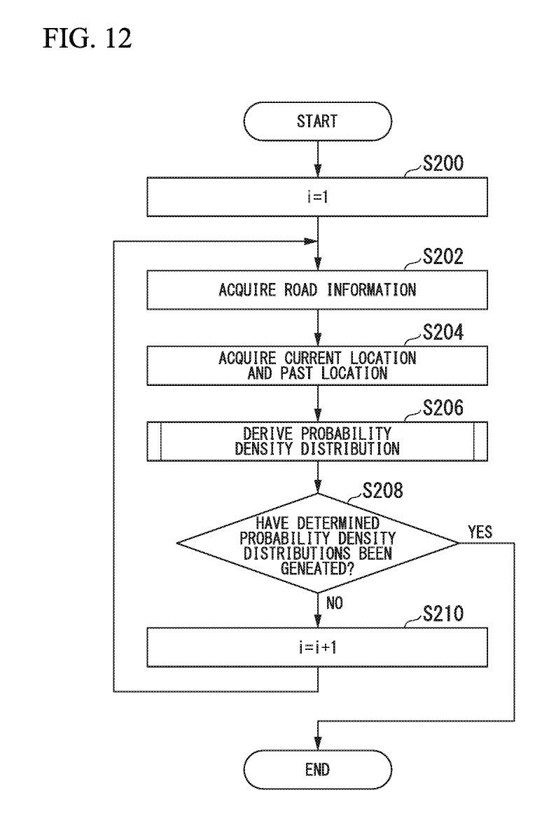

FIG. 12 is a flowchart illustrating an example of a process flow through which the second estimation unit 124 derives a probability density distribution PD of future locations. First, the second estimation unit 124 sets a parameter i to 1 which is an initial value (step S200). The parameter i indicates how many steps ahead prediction needs to be performed when prediction is performed in temporal step width intervals, for example. A larger number of the parameter i indicates earlier prediction.

Next, the second estimation unit 124 acquires road information included in the map information 152 necessary for predicting future locations of surrounding vehicles (step S202). Subsequently, the second estimation unit 124 acquires current locations and past locations of the surrounding vehicles from the environment recognition unit 104 (step S204). The current locations acquired in step S204 may be treated as “past locations” in the following processes in processing of the loop of steps S204 to S210.

Next, the second estimation unit 124 derives a probability density distribution PD of future locations of the surrounding vehicles on the basis of the road information acquired in step S202, the current locations and the past locations of the surrounding vehicles, acquired in step S204, and locations of the surrounding vehicles, predicted in the past (step S206). Additionally, when the current locations of the surrounding vehicles cannot be acquired from the environment recognition unit 104 in step S204, the second estimation unit 124 may use the locations of the surrounding vehicles, predicted in the past, as the current locations of the surrounding vehicles.

Subsequently, the second estimation unit 124 determines whether probability density distributions PD of a determined number of steps have been derived (step S208). When it is determined that the probability density distributions PD of the determined number of steps have not been derived, the second estimation unit 124 increments the parameter i by 1 (step S210) and proceeds to the process of step S202. When it is determined that the probability density distributions PD of the determined number of steps have been derived, the process of the present flowchart ends. Additionally, the determined number of steps is preferably 1 or more. The second estimation unit 124 may derive a probability density distribution PD of 1 step or probability density distributions PD of multiple steps.

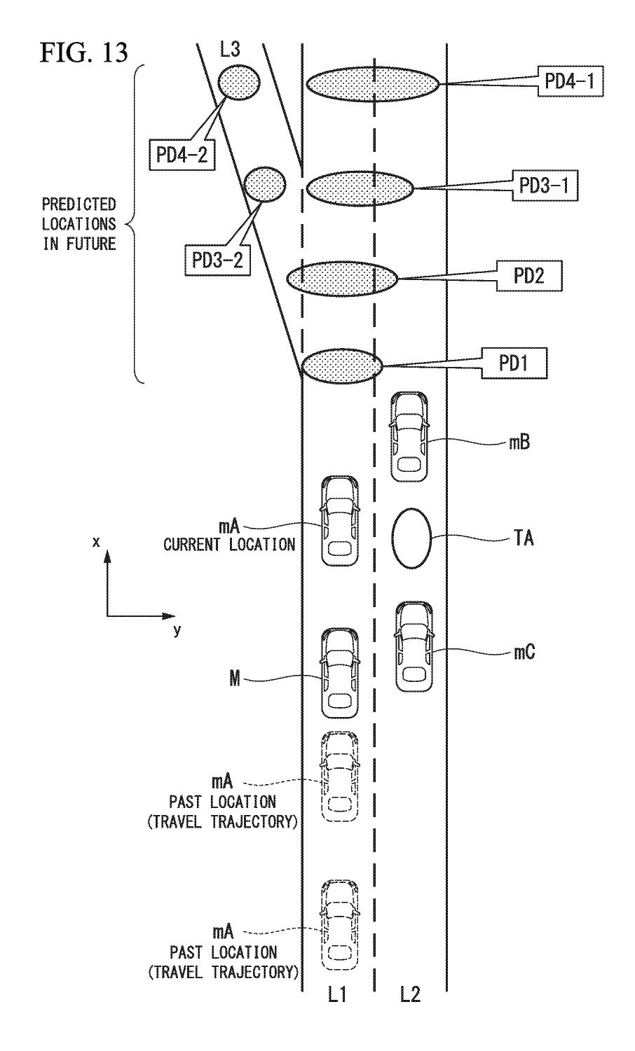

FIG. 13 is a diagram schematically illustrating derivation of probability density distributions PD. The second estimation unit 124 derives a probability density distribution PD for each step (corresponding to the parameter i) on the basis of road information, and the current locations, past location and predicted future locations of the surrounding vehicles. In the example of FIG. 13, the second estimation unit 124 derives probability density distributions PD1 to PD4-1 and PD4-2 corresponding to 4 steps. Further, prediction of future locations with respect to the preceding vehicle mA is illustrated in the example of FIG. 13. The second estimation unit 124 may perform the same process for other surrounding vehicles in addition to the preceding vehicle mA.

For example, the second estimation unit 124 derives a probability density distribution with respect to a surrounding vehicle having a likelihood of interfering in lane change of the host vehicle M. For example, the surrounding vehicle having a likelihood of interfering in lane change of the host vehicle M is a surrounding vehicle (e.g., the preceding vehicle mA) having a likelihood of changing changes lanes to the target location TA.

In addition, the surrounding vehicle having a likelihood of interfering in lane change of the host vehicle M is a surrounding vehicle (e.g., the rear reference vehicle mC) which changes lanes to move in front of the host vehicle M from the adjacent lane and has a likelihood of causing the host vehicle M to reduce speed on the lane on which the host vehicle M is traveling, for example. In this case, the host vehicle M has a likelihood of being hindered from changing lanes to the target location TA because it is caused to reduce speed.

First, the second estimation unit 124 derives the probability density distribution PD1 of the first step on the basis of the current locations and past locations of the surrounding vehicles. Then, the second estimation unit 124 derives the probability density distribution PD2 of the second step on the basis of the current locations and past locations of the surrounding vehicles and the probability density distribution PD1 derived in the first step. Thereafter, the second estimation unit 124 derives the probability density distributions PD3-1 and PD3-2 of the third step on the basis of the current locations and past locations of the surrounding vehicles, the derived probability density distribution PD1 of the first step and the derived probability density distribution PD2 of the second step. In addition, in the same manner, the second estimation unit 124 derives the probability density distributions PD4-1 and PD4-2 of the fourth step on the basis of the current locations and past locations of the surrounding vehicles and the derived probability density distribution PD (PD1 to PD3-2) of each step.

For example, when the probability density distribution PD1 has been derived, the second estimation unit 124 may predict locations of the surrounding vehicles corresponding to the first step on the basis of the probability density distribution PD1. In addition, when the probability density distributions PD1 to PD4-2 have been derived, for example, the second estimation unit 124 may predict locations of the surrounding vehicles from the first to fourth steps on the basis of the probability density distributions PD1 to PD4-2. In this manner, the second estimation unit 124 may predict future locations of the surrounding vehicles corresponding to any step on the basis of the derived probability density distribution PD.

Further, the second estimation unit 124 derives the probability density distribution PD such that the spread of the probability density distribution PD tends to be widened with increasing time into the future when the surrounding vehicles are traveling. This will be described later.

In addition, the second estimation unit 124 may derive the probability density distribution PD for each reference distance instead of each temporal step. Furthermore, the second estimation unit 124 may limit a range in which the probability density distribution PD is derived before a range in which surrounding vehicles are recognized by the environment recognition unit 104. In this manner, the second estimation unit 124 predicts locations of the surrounding vehicles using road information and thus can accurately predict locations of vehicles.

In addition, the second estimation unit 124 may derive the probability density distribution PD on the basis of current states of the surrounding vehicles without reference to the road information included in the map information 152. For example, the current states of the surrounding vehicles are relative locations and relative angles of the surrounding vehicles with respect to lanes on which the surrounding vehicles are traveling. In this case, the second estimation unit 124 derives the probability density distribution PD with reference to a table in which the relative angles with respect to the lanes on which the surrounding vehicles are traveling are correlated to future locations, stored in the storage unit 150 in advance.

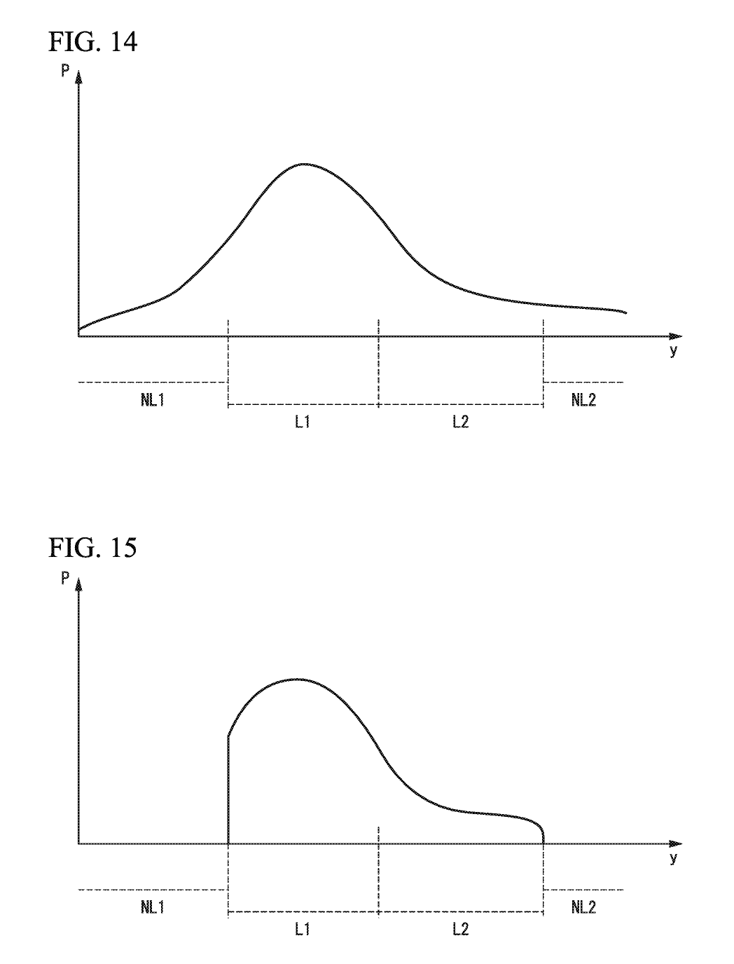

FIG. 14 is an example of the probability density distribution PD. The vertical axis P represents an existence probability density of a surrounding vehicle (e.g., the preceding vehicle mA) and the horizontal axis represents a horizontal displacement on a road. In addition, regions L1 and L2 partitioned using dotted lines indicate virtual lanes L1 and L2 for description. Regions NL1 and NL2 indicate virtual areas in which there is no road for description.

FIG. 15 is an example of the probability density distribution PD derived in consideration of road information. In this case, an existence probability density of a surrounding vehicle is not calculated (is calculated as zero) in a portion in which there is no road, and the existence probability density of the surrounding vehicle is calculated within the width of a road. It is possible to derive a probability density distribution PD in consideration of road information such as lanes and widths of roads by deriving the probability density distribution PD through the correction unit 123 using the road information of the map information 152. As a result, it is possible to accurately predict future locations of vehicles.

For example, the second estimation unit 124 derives a probability density distribution PD regardless of road information, corrects the probability density distribution PD on the basis of the road information and derives a probability density distribution PD in consideration of the road information. For example, the second estimation unit 124 derives the corrected probability density distribution PD by adding a probability density of a portion in which the existence probability density is calculated as zero to other portions. The adding method is not particularly limited but addition may be performed through a distribution conforming to a normal distribution on the basis of an average value in y-direction, for example.

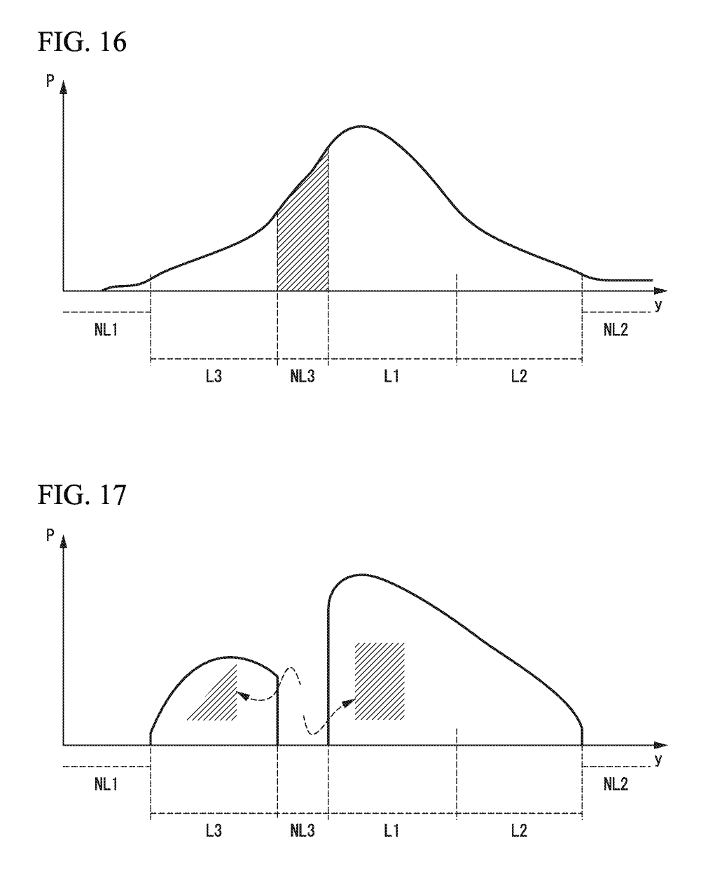

FIG. 16 is an example of a probability density distribution PD derived regardless of road information when a road branches off. Regions L1, L2 and L3 partitioned using dotted lines represent virtual lanes L1, L2 and L3 for description. In FIG. 16, L3 is a lane branching from the lanes L1 and L2 (refer to FIG. 13).

FIG. 17 is an example of a probability density distribution PD derived in consideration of road information when a road branches off. In the present embodiment, the second estimation unit 124 may derive a probability density distribution PD considering a branching lane in order to derive the probability density distribution PD using the road information. The second estimation unit 124 may derive the probability density distribution PD considering the branching lane by distributing a probability density of a region NL3 in which there is no road to the lanes L1 and L2 and the branching lane L3. For example, the second estimation unit 124 derives the probability density distribution PD considering the branching lane by distributing the probability density of the region NL3 depending on the ratio of probability densities of the lanes L1 and L2 to the probability density of the branching lane L3. Accordingly, the second estimation unit 124 can derive the probability density distribution PD considering the branching lane.

Specifically, the second estimation unit 124 derives a probability density distribution PD of future locations of a surrounding vehicle on the basis of the location of the surrounding vehicle, road information and the following equation (1) which is a probability density function, for example. The second estimation unit 124 calculates the value of the function f for each displacement (x, y). For example, x is a relative displacement regarding the travelling direction of the surrounding vehicle with respect to the host vehicle M. For example, y is a horizontal displacement of the surrounding vehicle. μₓ is an average of relative displacements (past, current or future relative displacements) in the travelling direction of the surrounding vehicle with respect to the host vehicle M. μ_{y} is an average of locations (past, current or future locations) in the lateral direction of the surrounding vehicle. σ2ₓ is a variance of relative displacements in the travelling direction of the surrounding vehicle. σ2_{y} is a variance of locations in the lateral direction of the surrounding vehicle.

$$\begin{matrix}[ Math . 1 ] & \\ f ( x , y ) = exp ( - \frac{{( x - {μ}_{x} )}^{2}}{2 {σ}_{x}^{2}} - \frac{{( y - {μ}_{y} )}^{2}}{2 {σ}_{y}^{2}} ) & ( 1 )\end{matrix}$$

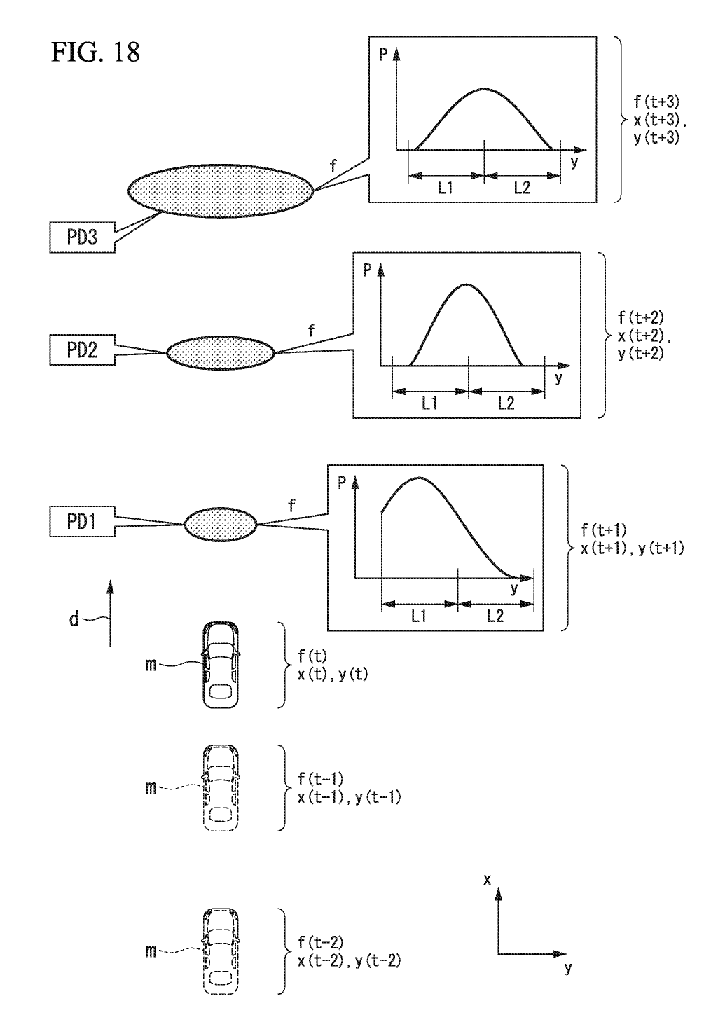

The second estimation unit 124 derives the probability density distribution PD on the basis of changes in the current location, past location or future location of the surrounding vehicle, road information, and the probability density function f. FIG. 18 is a diagram for describing derivation of a probability density distribution PD of future locations of a surrounding vehicle m.

If the current location is t, when the probability density distribution PD1 is obtained, the probability density function f is calculated using the current location (x(t), y(t)) and past locations (x(t−1), y(t−1)) and (x(t−2), y(t−2)) as parameters, and consequently the probability density distribution PD1 is obtained. When PD2 is obtained, the probability density function f is calculated using the current location (x(t), y(t)), past locations (x(t−1), y(t−1)) and (x(t−2), y(t−2)) and a future location (x(t+1), y(t+1)) as parameters, and consequently the probability density distribution PD2 is obtained. When PD3 is obtained, the probability density function f is calculated using the current location (x(t), y(t)), past locations (x(t−1), y(t−1)) and (x(t−2), y(t−2)) and future locations (x(t+1), y(t+1)) and (x(t+2), y(t+2)) as parameters, and consequently the probability density distribution PD3 is obtained.

In this manner, prediction is performed in a ripple fashion while reflecting prediction results. Consequently, when a surrounding vehicle changes paths to the right, for example, the average μ_{y} follows the tendency and thus the right side of the probability density distribution PD tends to be thick. Accordingly, when the surrounding vehicle intends to change lanes, an existence probability of the lane change destination can be predicted to be high.

The limit time calculation unit 125 predicts future locations of surrounding vehicles through existence probabilities for each lane on the basis of the probability density distribution PD in the derived f(t). For example, the limit time calculation unit 125 derives an existence probability for each lane by integrating probability density on a lane for each lane.

Additionally, the second estimation unit 124 may derive the probability density distribution PD using a location history of a surrounding vehicle. For example, when a y-direction displacement of the surrounding vehicle is continuously moving to one side, a probability distribution may be further biased in the direction in which the y-direction displacement is moving than a range conforming the average μ_{y}. Specifically, the correction unit 123 can bias probability density in the y-direction by adjusting a skew (degree of skew: third moment) in a normal distribution.

### Lane Change Event of Second Embodiment

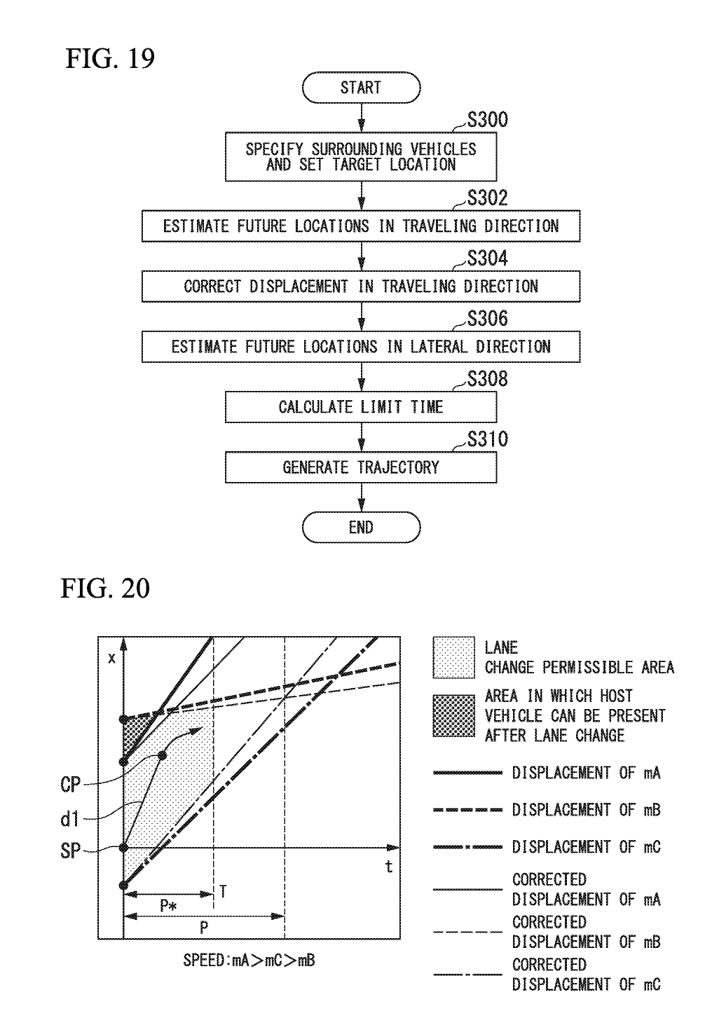

FIG. 19 is a flowchart illustrating a process flow executed by the lane change control unit 120. First, the target location setting unit 121 identifies surrounding vehicles (e.g., the preceding vehicle mA, the front reference vehicle mB and the rear reference vehicle mC) and sets a target location TA between the identified surrounding vehicles (step S300).

Next, the first estimation unit 122 estimates future displacements (future locations) of the preceding vehicle mA, the front reference vehicle mB and the rear reference vehicle mC (step S302). Subsequently, the correction unit 123 corrects the future displacements of the surrounding vehicles, estimated by the first estimation unit 122, as a distribution having a spread in the travelling direction with the elapse of time (step S304). The correction unit 123 executes the same process as step S104 of the first embodiment.

Next, the second estimation unit 124 estimates future locations in the lateral direction of a surrounding vehicle having a likelihood of interfering in lane change of the host vehicle M (step S306). Subsequently, the limit time calculation unit 125 calculates a limit time on the basis of the future locations in the lateral direction of the surrounding vehicle, estimated by the second estimation unit 124 (step S308). For example, the limit time calculation unit 125 calculates a time at which an existence probability of the surrounding vehicle existing on a lane change destination of the host vehicle M changes from a value less than a threshold value to a value equal to or greater than the threshold value from as the limit time on the basis of the probability density distribution PD.

FIG. 20 is a diagram illustrating an example of correction of future displacements of surrounding vehicles in the second embodiment. Redundant description in FIG. 9 is omitted. In the example of FIG. 9, the future displacements of the surrounding vehicles, corrected by the correction unit 123, are displacements in the travelling direction of the surrounding vehicles, and horizontal displacements are not added thereto.

Additionally, the limit time calculation unit 125 derives a limit time T which is a time at which a surrounding vehicle is expected to change lanes to the target location TA, a time at which a surrounding vehicle is expected to change lanes immediately in front of the host vehicle M prior to completion of lane change of the host vehicle M, or the like. A lane change permissible period is changed from “P” to “P*” such that the end point of the lane change permissible period becomes the limit time T.

Subsequently, the second trajectory generation unit 128 generates a trajectory for the host vehicle M to change lanes to the target location TA (step S310). The second trajectory generation unit 128 determines a lane change end point CP such that the lane change end point CP precedes the lane change permissible period P*. In addition, the second trajectory generation unit 128 generates a trajectory d1 for changing lanes on the basis of determined lane change start point SP and end point CP. Further, when a plurality of limit times T are calculated by the limit time calculation unit 125, the second trajectory generation unit 128 may employ a latest limit time T among the limit times T. Accordingly, the process of the present flowchart ends.

The vehicle control device 100A in the second embodiment, described above, can generate a trajectory for changing lanes more accurately by generating a target trajectory of future locations of the host vehicle M for changing lanes while avoiding surrounding vehicles traveling on lanes adjacent to the host lane on the basis of future locations in the travelling direction of surrounding vehicles, corrected by the correction unit 123, and a limit time calculated by the limit time calculation unit 125.

### Third Embodiment

Hereinafter, a third embodiment will be described. In the second embodiment, the vehicle control device 100A generates a target trajectory of the host vehicle on the basis of future locations in the travelling direction of the surrounding vehicles, corrected by the correction unit 123, and a limit time calculated by the limit time calculation unit 125. On the other hand, the third embodiment differs from the second embodiment in that a vehicle control device 100B generates a target trajectory of future locations of the host vehicle on the basis of a limit time calculated by the limit time calculation unit 125 without correcting future locations in the directions of travel of the surrounding vehicles. Such a difference will be mainly described below.

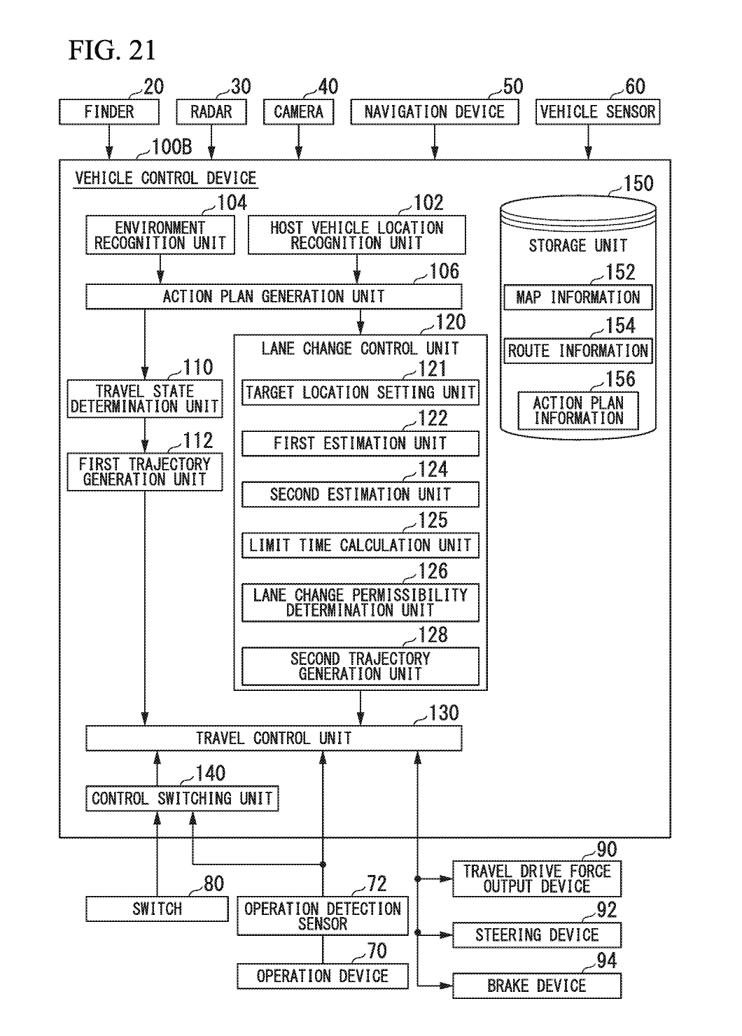

FIG. 21 is a diagram showing a functional configuration of the host vehicle M focusing on the vehicle control device 100B according to the third embodiment. The lane change control unit 120 of the vehicle control device 100B includes the target location setting unit 121, the first estimation unit 122, the second estimation unit 124, the limit time calculation unit 125, the lane change permissibility determination unit 126, and the second trajectory generation unit 128. In the lane change control unit 120 of the third embodiment, the correction unit 123 is omitted.

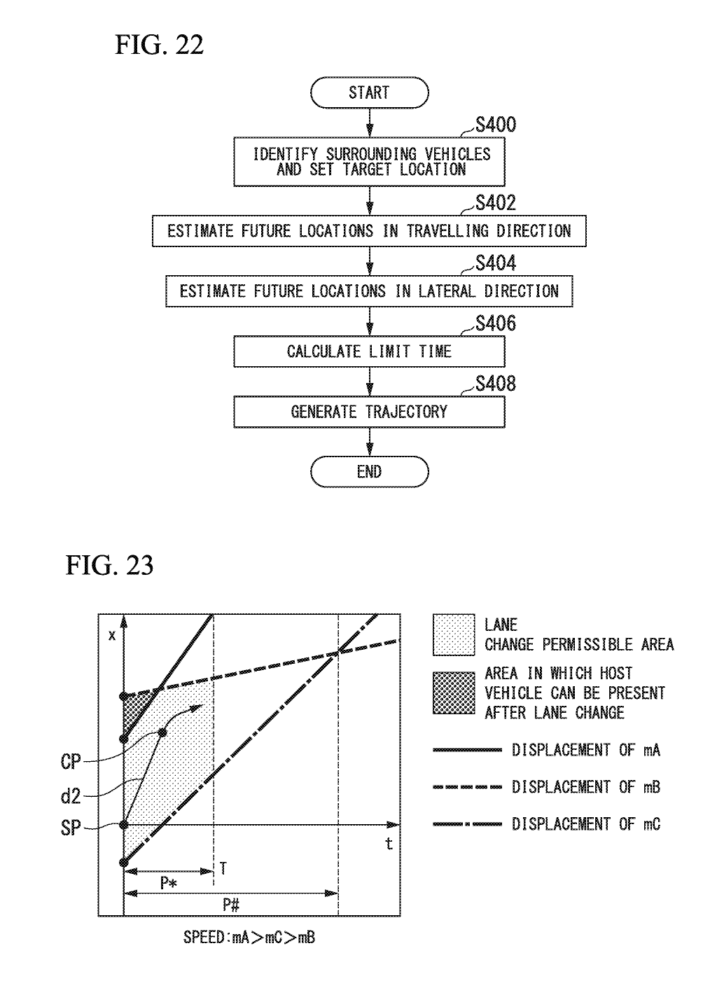

FIG. 22 is a flowchart illustrating a process flow executed by the lane change control unit 120. First, the target location setting unit 121 identifies surrounding vehicles and sets a target location TA between the identified surrounding vehicles (step S400). Then, the first estimation unit 122 estimates future displacements in the travelling direction of the surrounding vehicles (step S402).

Subsequently, the second estimation unit 124 estimates future locations in the lateral direction of the surrounding vehicles (step S404). Thereafter, the limit time calculation unit 125 calculates a limit time on the basis of the future locations in the lateral direction of the surrounding vehicles, estimated by the second estimation unit 124 (step S406).

Next, the second trajectory generation unit 128 generates a trajectory for the host vehicle M to change lanes to the target location TA (step S408). Accordingly, the process of the present flowchart ends.

FIG. 23 is a diagram illustrating an example of correction of future displacements of surrounding vehicles in the third embodiment. Redundant description in FIG. 9 is omitted. The limit time calculation unit 125 derives, for example, a time at which an existence probability of a surrounding vehicle existing on a lane change destination of the host vehicle M exceeds a threshold value with reference to a probability density distribution PD. A lane change permissible period is changed from “P#” to “P*” such that the end point of the lane change permissible period becomes a limit time T. The second trajectory generation unit 128 determines a lane change end point CP such that the lane change end point CP precedes the lane change permissible period P*. In addition, the second trajectory generation unit 128 generates a trajectory d2 for changing lanes on the basis of determined lane change start point SP and end point CP. Consequently, the vehicle control device 100B can avoid a state in which lanes cannot be appropriately changed according to displacement of the surrounding vehicles to locations deviated in the lateral direction.

The vehicle control device 100B in the third embodiment, described above, can generate a trajectory for changing lanes more accurately by generating a target trajectory of future locations of the host vehicle M for changing lanes while avoiding surrounding vehicles traveling on lanes adjacent to the host lane on the basis of the limit time calculated by the limit time calculation unit 125.

Although embodiments of the present invention have been described above, the present invention is not limited to such embodiments and various modifications and substitutions can be made without departing from the spirit or scope of the present invention.

### REFERENCE SIGNS LIST

20 Finder

30 Radar

40 Camera

50 Navigation device

60 Vehicle sensor

70 Operation device

72 Operation detection sensor

80 Switch

90 Travel drive force output device

92 Steering device

94 Brake device

100, 110A, 100B Vehicle control device

102 Host vehicle location recognition unit

104 Environment recognition unit

106 Action plan generation unit

110 Travel state determination unit

112 First trajectory generation unit

120 Lane change control unit

121 Target location setting unit

122 First estimation unit

123 Correction unit

124 Second estimation unit

125 Limit time calculation unit

126 Lane change permissibility determination unit

128 Second trajectory generation unit

130 Travel control unit

140 Control switching unit

150 Storage unit

M Vehicle

What is claim is:

1. A vehicle control device comprising:
a detection unit configured to detect surrounding vehicles traveling around a host vehicle;
a first estimation unit configured to estimate future locations in a travelling direction of the surrounding vehicles detected by the detection unit;
a correction unit configured to correct a distribution of the future locations in the travelling direction of the surrounding vehicles estimated by the first estimation unit, the distribution having a spread in the travelling direction with an elapse of time; and
a control unit configured to, on the basis of the distribution of the surrounding vehicles corrected by the correction unit, generate a target trajectory of the host vehicle for changing lanes while avoiding the surrounding vehicles traveling on lanes adjacent to a host lane.

2. The vehicle control device according to claim 1, wherein the correction unit corrects the distribution such that an edge of the distribution approaches a side which interferes with a lane change destination of the host vehicle on the basis of relative locations between the host vehicle and the surrounding vehicles.

3. The vehicle control device according to claim 1, wherein the first estimation unit estimates the future locations in the travelling direction of the surrounding vehicles on the assumption that the surrounding vehicles travel while maintaining current speeds or on the assumption that the surrounding vehicles travel while maintaining current accelerations.

4. The vehicle control device according to claim 1, further comprising:
a second estimation unit configured to estimate future locations in a lateral direction of the surrounding vehicles detected by the detection unit; and
a calculation unit configured to calculate a limit time of lane change of the host vehicle on the basis of the future locations in the lateral direction of the surrounding vehicles estimated by the second estimation unit,
wherein the control unit generates the target trajectory of the host vehicle on the basis of the distribution of the surrounding vehicles corrected by the correction unit and the limit time calculated by the calculation unit.

5. The vehicle control device according to claim 4, wherein the second estimation unit estimates a distribution of the future locations in the lateral direction of the surrounding vehicles, the distribution having a spread in the lateral direction, and
the calculation unit calculates the limit time on the basis of a time at which integral values of probability density functions corresponding to lane change destinations of the surrounding vehicles change from values less than a threshold value to values equal to or greater than the threshold value in the distribution estimated by the second estimation unit.

6. The vehicle control device according to claim 4, wherein the second estimation unit estimates the future locations in the lateral direction of the surrounding vehicles on the basis of road information of roads around the surrounding vehicles.

7. A vehicle control device comprising:
a detection unit configured to detect surrounding vehicles traveling around a host vehicle;
an estimation unit configured to estimate future locations in the lateral direction of the surrounding vehicles detected by the detection unit;
a calculation unit configured to calculate a limit time of lane change of the host vehicle on the basis of the future locations in the lateral direction of the surrounding vehicles estimated by the estimation unit; and
a control unit configured to, on the basis of the limit time calculated by the calculation unit, generate a target trajectory of the host vehicle for changing lanes while avoiding the surrounding vehicles traveling on lanes adjacent to a host lane.

8. A vehicle control method, performed by a computer, comprising:
detecting surrounding vehicles traveling around a host vehicle;
estimating future locations in a travelling direction of the surrounding vehicles;
correcting a distribution of the future locations in the travelling direction of the surrounding vehicles, the distribution having a spread in the travelling direction with the elapse of time; and
generating a target trajectory of the host vehicle for changing lanes while avoiding the surrounding vehicles traveling on lanes adjacent to a host lane on the basis of the corrected distribution of the surrounding vehicles.

9. A vehicle control program for causing a computer to execute a process comprising:
detecting surrounding vehicles traveling around a host vehicle;
estimating future locations in a travelling direction of the surrounding vehicles;
correcting a distribution of the future locations in the travelling direction of the surrounding vehicles, the distribution having a spread in the travelling direction with the elapse of time; and
generating a target trajectory of the host vehicle for changing lanes while avoiding the surrounding vehicles traveling on lanes adjacent to a host lane on the basis of the corrected distribution of the surrounding vehicles.
